(19) United States
(12) Patent Application Publication
(10) Pub. No.: US 2006/0187329 A1
(43) Pub. Date: Aug. 24, 2006

(54) Clamped capacitor readout noise rejection circuit for imagers

(75) Inventor: Roger Panicacci, Los Angeles, CA (US)

Correspondence Address: DICKSTEIN SHAPIRO MORIN & OSHINSKY LLP, 2101 L Street, NW, Washington, DC, 20037, US

(73) Assignee: MICRON TECHNOLOGY, INC.

(21) Appl. No.: 11/064,503

(22) Filed: Feb. 24, 2005

(51) Int. Cl. H04N 5/335; H04N 3/14; H01L 31/062; H01L 31/113

(52) U.S. Cl. 348/308

(57) ABSTRACT

An imaging device with readout chain circuitry that uses cascaded gain stages to amplify pixel and reset signals from odd and even columns of pixels. The readout chain shares amplifiers between odd and even channels. The last stage of the chain includes noise suppression circuitry designed to suppress kTC and amplifier thermal noise during the readout process.

### FIELD OF THE INVENTION

The invention relates generally to imaging devices and more particularly to a clamped capacitor readout noise rejection circuit for an imaging device.

### BACKGROUND

A CMOS imager circuit includes a focal plane array of pixel cells, each one of the cells including a photosensor, for example, a photogate, photoconductor or a photodiode overlying a substrate for accumulating photo-generated charge in the underlying portion of the substrate. Each pixel cell has a readout circuit that includes at least an output field effect transistor formed in the substrate and a charge storage region formed on the substrate connected to the gate of an output transistor. The charge storage region may be constructed as a floating diffusion region. Each pixel may include at least one electronic device such as a transistor for transferring charge from the photosensor to the storage region and one device, also typically a transistor, for resetting the storage region to a predetermined charge level prior to charge transference.

In a CMOS imager, the active elements of a pixel cell perform the necessary functions of: (1) photon to charge conversion; (2) accumulation of image charge; (3) resetting the storage region to a known state before the transfer of charge to it; (4) transfer of charge to the storage region accompanied by charge amplification; (5) selection of a pixel for readout; and (6) output and amplification of a signal representing pixel charge. Photo charge may be amplified when it moves from the initial charge accumulation region to the storage region. The charge at the storage region is typically converted to a pixel output voltage by a source follower output transistor.

CMOS imagers of the type discussed above are generally known as discussed, for example, in U.S. Pat. No. 6,140,630, U.S. Pat. No. 6,376,868, U.S. Pat. No. 6,310,366, U.S. Pat. No. 6,326,652, U.S. Pat. No. 6,204,524 and U.S. Pat. No. 6,333,205, assigned to Micron Technology, Inc., which are hereby incorporated by reference in their entirety.

A typical four transistor (4 T) CMOS imager pixel 10 is shown in FIG. 1. The pixel 10 includes a photosensor 12 (e.g., photodiode, photogate, etc.), transfer transistor 14, floating diffusion region FD, reset transistor 16, source follower transistor 18 and row select transistor 20. The photosensor 12 is connected to the floating diffusion region FD by the transfer transistor 14 when the transfer transistor 14 is activated by a transfer gate control signal TX.

The reset transistor 16 is connected between the floating diffusion region FD and an array pixel supply voltage Vaa_pix. A reset control signal RST is used to activate the reset transistor 16, which resets the floating diffusion region FD to the array pixel supply voltage Vaa_pix level as is known in the art.

The source follower transistor 18 has its gate connected to the floating diffusion region FD and is connected between the array pixel supply voltage Vaa_pix and the row select transistor 20. The source follower transistor 18 converts the charge stored at the floating diffusion region FD into an electrical output voltage signal Vout. The row select transistor 20 is controllable by a row select signal SEL for selectively connecting the source follower transistor 18 and its output voltage signal Vout to a column line 22 of a pixel array.

A typical CMOS imager 50 is illustrated in FIG. 2. The imager 50 includes a pixel array 52 connected to column sample and hold (S/H) circuitry 54. The pixel array 52 comprises a plurality of pixels arranged in a predetermined number of rows and columns. In operation, the pixels of each row in the array 52 are all turned on at the same time by a row select line and the pixels of each column are selectively output on a column line. A plurality of row and column lines are provided for the entire array 52.

The row lines are selectively activated by row decoder and driver circuitry (not shown) in response to an applied row address. Column select lines are selectively activated by column decoder 56 and driver circuitry contained within the column sample and hold circuitry 54 in response to an applied column address. Thus, a row and column address is provided for each pixel. The CMOS imager 50 is operated by a control circuit (not shown), which controls the row and column circuitry for selecting the appropriate row and column lines for pixel readout.

The CMOS imager 50 illustrated in FIG. 2 uses a dual channel readout architecture. That is, the imager 50 includes a first channel (designated as G1/G2) and a second channel (designated as R/B) for pixel and reset signals read out of the array 52. Each readout channel G1/G2, R/B is used to read out half the number of pixels connected to the column S/H circuitry 54. The first channel G1/G2 outputs analog reset and pixel signals associated with green pixels while the second channel R/B outputs analog reset and pixel signals associated with red and blue pixels.

Once read out, the green analog reset and pixel signals pass through an amplifier (PGA) 58 and an analog-to-digital converter (ADC) 62 before being processed as digital signals by digital block 66. Amplifier 58 and ADC 62 comprise a green port of the imager 50. Once read out, the blue and red analog reset and pixel signals pass through an amplifier (PGA) 60 and an analog-to-digital converter (ADC) 64 before being processed as digital signals by digital block 66. Amplifier 60 and ADC 64 comprise a red/blue port of the imager 50.

FIG. 3 illustrates a portion of the column S/H circuitry 54. As can be seen from FIG. 3, there is circuitry for the green channel G1/G2 and separate circuitry for the red/blue channel R/B. The components connected to the green channel G1/G2 include a crowbar switch 70g, two sample and hold switches 72g, 82g, two sample and hold capacitors 74g, 84g, two clamping switches 76g, 86g, two fine decode switches 78g, 88g, and two group decode switches 80g, 90g. The components connected to the red/blue channel R/B include a crowbar switch 70r, two sample and hold switches 72r, 82r, two sample and hold capacitors 74r, 84r, two clamping switches 76r, 86r, two fine decode switches 78r, 88r, and two group decode switches 80r, 90r.

The clamping switches 76r, 76g, 86r, 86g are used to place a clamp voltage VCL on one plate of the S/H capacitors 74r, 74g, 84r, 84g. S/H switches 72r, 72g in response to a sample and hold pixel control signal SHS are used to store analog pixel signals on S/H capacitors 74r, 74g. S/H switches 82r, 82g in response to a sample and hold reset control signal SHR are used to store analog reset signals on S/H capacitors 84r, 84g. The crowbar switches 70r, 70g are used to read out the signals stored in the S/H capacitors 74r, 84r, 74g, 84g. The fine decode switches 78r, 88r, 78g, 88g are closed in response to a fine decode control signal (when a single column address is being decoded). The group decode switches 80r, 90r, 80g, 90g are closed in response to a group decode control signal (when multiple column addresses are being decoded).

FIGS. 4-6 illustrate the components and operation of a readout chain 100 for imager 50. The illustrated chain 100 includes three stages: stage 1 is a first analog signal chain ASC1, stage 2 is a second analog signal chain ASC2, and the third stage is an analog-to-digital sample and hold stage ADCSH. The stages are operated in two phases referred to herein as PHI1, PHI 2.

Column sample and hold circuitry 54 is connected to the first analog signal chain ASC1. The illustrated column S/H circuitry 54 is for one channel and includes the components described above with respect to FIG. 3, but for a single channel. That is, the S/H circuitry includes a crowbar switch 70, two sample and hold switches 72, 82, two sample and hold capacitors 74, 84, two clamping switches 76, 86, two fine decode switches 78, 88, and two group decode switches 80, 90.

The first analog signal chain ASC1 includes parasitic capacitance 102, 104, ten switches 106, 108, 112, 114, 120, 122, 124, 126, 128, 130, an amplifier 110, and two adjustable capacitors 116, 118. The first analog signal chain ASC1 is connected to the second analog signal chain ASC2.

The second analog signal chain ASC2 includes two adjustable capacitors 132, 136, eight switches 134, 138, 140, 144, 146, 152, 154, 156, 158, an amplifier 142, and two feedback capacitors 148, 150. The second analog signal chain ASC2 is connected to the analog-to-digital sample and hold stage ADCSH.

The analog-to-digital sample and hold stage ADCSH includes switches 160, 161, 162, 164, 166, 168, 176, 178, 182, 184, 186, 188, 192, 194, an amplifier 190, two input capacitors 170, 172 and two feedback capacitors 174, 180.

During the first phase PHI1 of operation, the chain 100 is operating on a current pixel n and a prior pixel n−1. The first analog signal chain ASC1 undergoes a reset/clamp operation at time t0. During this time, amplifier 110 is idle. Switches 106, 108, 112, 114, 120 and 130 are closed, connecting the first analog signal chain ASC1 to a common mode voltage Vcm, which is a voltage bias of approximately one-half of the power supply voltage.

At this time, the second analog signal chain is applying a gain to prior pixel n−1's signals. To do so, switches 140, 144, 154 and 156 are closed forming a completed first feedback path through switch 154, capacitor 148 and switch 140 to a first input of amplifier 142 and a completed second feedback path through switch 156, capacitor 150 and switch 144 to a second input of amplifier 142. Also during this time, the analog-to-digital sample and hold stage ADCSH undergoes a reset/sample operation on pixel n−1. This is accomplished by closing switches 160, 161, 166 and 168.

During the second phase PHI2 of operation, the first and second analog signal chains ASC1, ASC2 operate on the current pixel n, while the analog-to-digital S/H stage ADCSH operates on prior pixel n−1. The first analog signal chain ASC1 inputs two analog pixel signals from the S/H circuitry 54 (i.e., crowbar switch 70 is closed) and applies a gain to these signals at time t1. During this time, amplifier 110 is active. Switches 108, 112, 122, 128, 124, and 126 are closed. A first feedback path through switch 122, capacitor 116 and switch 108 to a first input of amplifier 110 is formed. A second feedback path through switch 128, capacitor 118 and switch 112 to a second input of amplifier 110 is also formed. The outputs of the first amplifier 110 are connected to the second analog signal chain ASC2 through closed switches 124, 126.

At this time, the second analog signal chain ASC2 is undergoing a reset/sample operation for pixel n in which amplifier 142 is idle. Switches 138, 140, 144, 146, 152, and 158 are closed connecting the second analog signal chain ASC2 to the common mode voltage Vcm.

Also during this time, the analog-to-digital sample and hold stage ADCSH applies a gain to prior pixel n−1. The gain is set by closing switch 162 connected to a positive reference voltage Vrefp, closing switch 164 connected to a negative reference voltage Vrefn, opening switches 160, 161, 166, 168, 176, and 186 and closing switches 182, 184, 186, 188, 192, and 194.

At time t2, the first phase PHI 1 occurs again. Here, the first analog signal chain ASC1 undergoes a reset/clamp operation for next pixel n+1, the second analog signal chain ASC2 applies a gain to pixel n, and the analog-to-digital sample and hold stage ADCSH undergoes the reset/sample operation for pixel n. The ADC outputs pixel n−10 at this time. At time t3, the second phase PHI 2 occurs again. Here, the first analog signal chain ASC1 applies a gain to pixel n+1, the second analog signal chain ASC2 undergoes a reset/clamp operation for the next pixel n+1, and the analog-to-digital sample and hold stage ADCSH applies a gain to the signals of pixel n. There is no ADC output at this time.

Referring to FIGS. 2-6, each analog-to-digital converter 62, 64 operates at 24 mega-samples/second, which equals one half of the imager's master clock rate. Having two ADC in parallel yields an effective rate of approximately 48 mega-samples/second. Thus, effectively, the master clock speed equals the conversion rate (known as single rate or “1×”).

The operation speed of the readout circuitry is inadequate. In addition, attempts to speed up the circuitry may introduce undesirable noise into the readout process. Accordingly, there is a need and desire to increase the operational speed of the readout chain circuitry without increasing the noise of the system.

### SUMMARY

The invention increases the operational speed of the readout chain circuitry used in imaging devices without increasing the noise of the device.

Various exemplary embodiments of the invention provide an imaging device with readout chain circuitry that uses cascaded gain stages to amplify pixel and reset signals from odd and even columns of pixels. The readout chain shares amplifiers between odd and even channels. The last stage of the chain includes noise suppression circuitry designed to suppress kTC and amplifier thermal noise during the readout process.

### BRIEF DESCRIPTION OF THE DRAWINGS

The foregoing and other advantages and features of the invention will become more apparent from the detailed description of exemplary embodiments provided below with reference to the accompanying drawings in which:

FIG. 1 illustrates a typical four transistor (4 T) CMOS imager pixel 10;

FIG. 2 is a diagram of a portion of a typical CMOS imager;

FIG. 3 illustrates a portion of the column S/H circuitry utilized in the FIG. 2 imager;

FIG. 4 is a timing diagram of the operation of the FIG. 2 imager;

FIG. 5 illustrates a portion of a readout chain used in the FIG. 2 imager in a first phase of operation;

FIG. 6 illustrates a portion of a readout chain used in the FIG. 2 imager in a second phase of operation;

FIG. 7 is a diagram of a portion of a CMOS imager;

FIG. 8 illustrates a portion of the column S/H circuitry utilized in the FIG. 7 imager;

FIG. 9 illustrates a portion of a readout chain used in the FIG. 7 imager in a first phase of operation;

FIG. 10 illustrates a portion of a readout chain used in the FIG. 7 imager in a second phase of operation;

FIG. 11 illustrates a readout chain constructed in accordance with an embodiment of the invention;

FIG. 12 illustrates a portion of the FIG. 11 readout chain;

FIG. 13 is a timing diagram of the operation of the FIG. 11 imager;

FIG. 14 illustrates a portion of the FIG. 11 readout chain in a first phase of operation;

FIG. 15 illustrates a portion of the FIG. 11 readout chain in a second phase of operation;

FIG. 16 illustrates a portion of the FIG. 11 readout chain in a third phase of operation;

FIG. 17 illustrates a portion of the FIG. 11 readout chain in a fourth phase of operation;

FIG. 18 illustrates a portion of a readout chain constructed in accordance with another embodiment of the invention;

FIGS. 19-23 illustrate portions of readout circuitry for corresponding noise calculations;

FIG. 24 illustrates a readout chain constructed in accordance with another embodiment of the invention;

FIG. 25 illustrates a portion of the FIG. 24 readout chain;

FIG. 26 is a timing diagram of the operation of the FIG. 24 imager;

FIG. 27 illustrates a portion of the FIG. 24 readout chain in a first phase of operation;

FIG. 28 illustrates a portion of the FIG. 24 readout chain in a second phase of operation;

FIG. 29 illustrates a portion of the FIG. 24 readout chain in a third phase of operation; and

FIG. 30 illustrates a system suitable for use with any one of the embodiments of the invention.

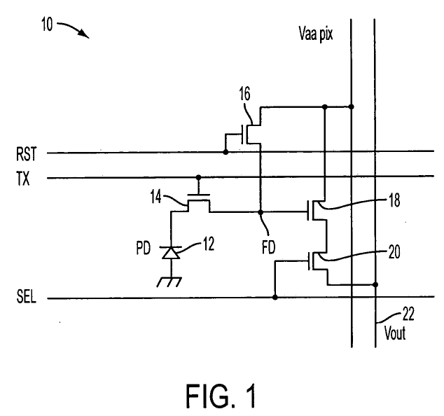

### DETAILED DESCRIPTION

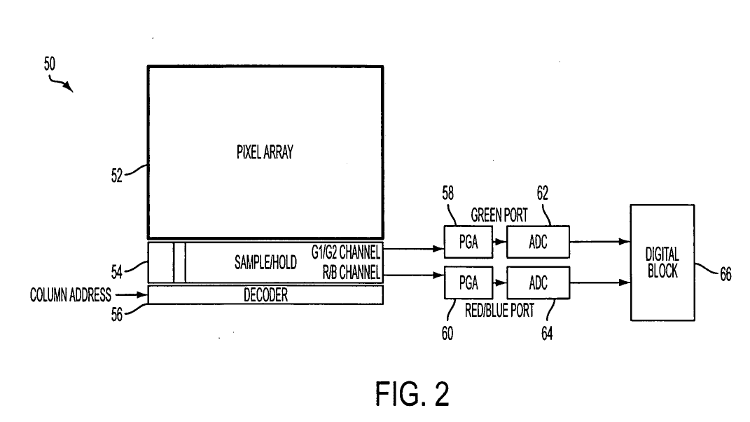

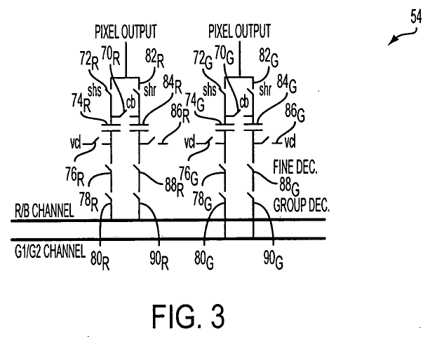

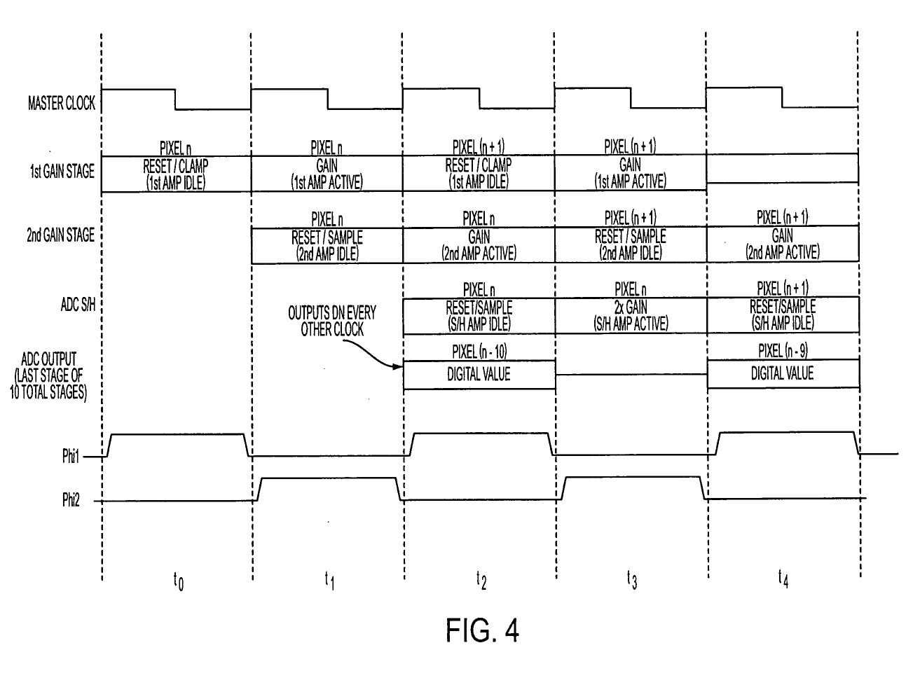

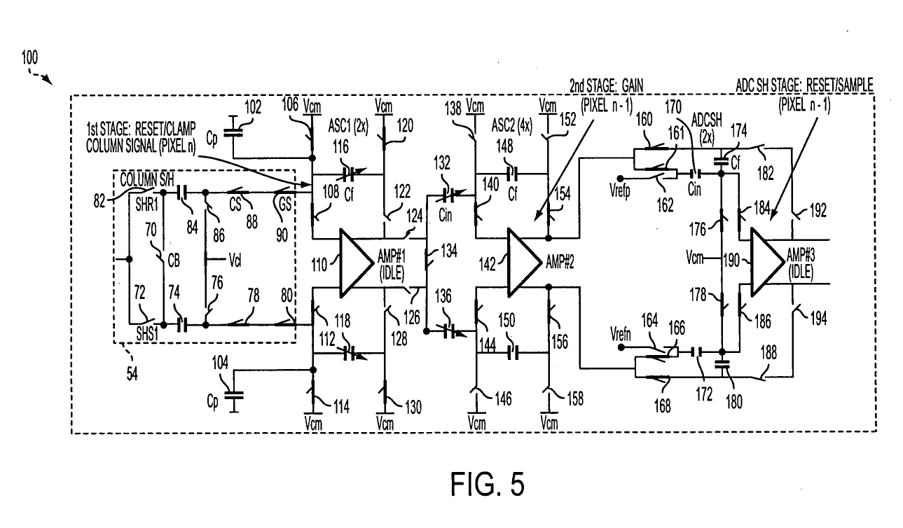

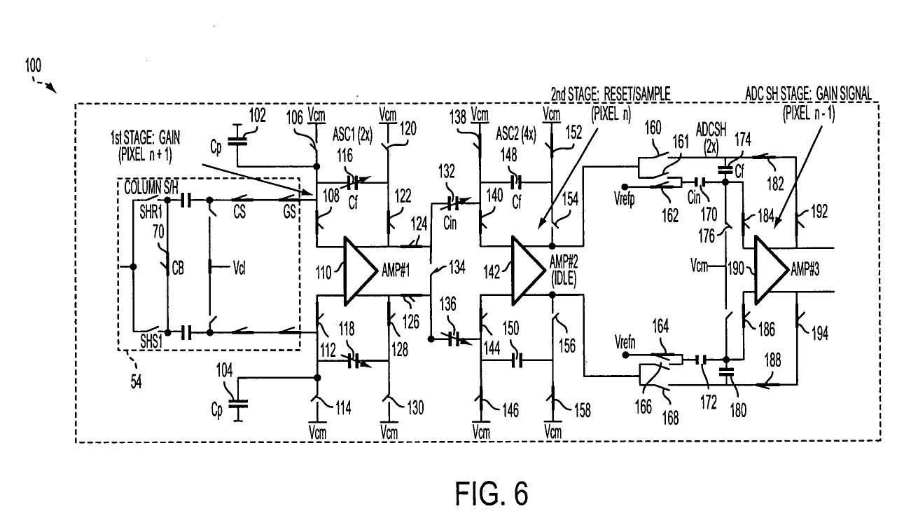

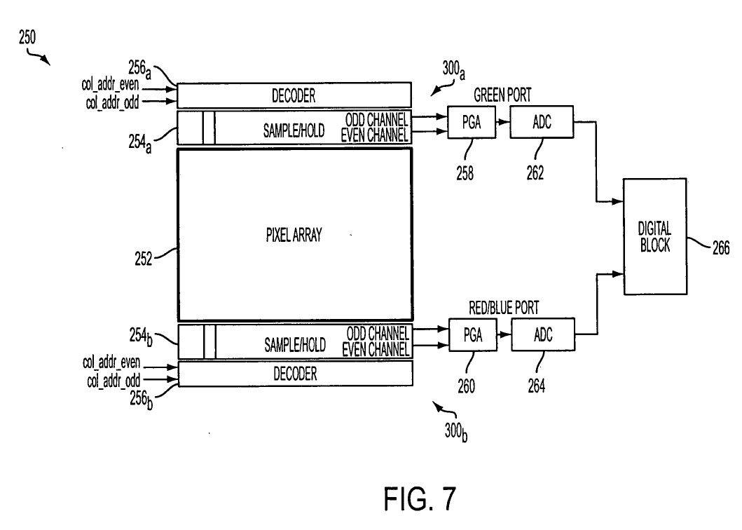

Referring to the figures, where like reference numbers designate like elements, FIG. 7 illustrates a portion of a CMOS imager 250 having improvements over the imager 50 illustrated in FIG. 2. The illustrated imager 250 includes a pixel array 252 connected to two column sample and hold (S/H) circuits 254a, 254b. The pixel array 252 comprises a plurality of pixels arranged in a predetermined number of rows and columns. The S/H circuits 254a, 254b are controlled by respective decoders 256a, 256b.

The imager 250 uses two dual channel readout chains 300a, 300b. As is described in more detail below, the chains 300a, 300b pipeline their respective gain stages to achieve a double rate readout. The first S/H circuit 254a is connected to an amplifier (PGA) 258 and an analog-to-digital converter (AD) 262 dedicated to green pixels; these components makeup chain 300a. The second is connected to an amplifier 260 and an analog-to-digital converter 264 dedicated to red/blue pixels; these components make up chain 300b. The outputs of the analog-to-digital converters 262, 264 are processed as digital signals by digital block 266. Amplifier 258 and ADC 262 comprise a green port of the imager 250. Amplifier 260 and ADC 264 comprise a red/blue port of the imager 250. Each chain 300a, 300b has an odd channel and an even channel. Thus, each decoder 256a, 256b inputs odd and even column addresses col_addr_odd, col_addr_even.

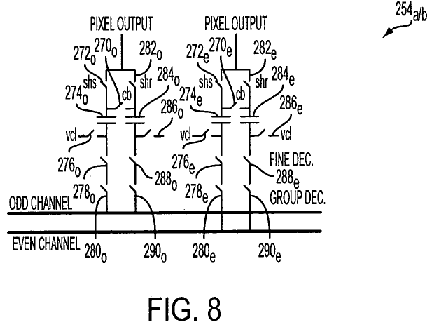

FIG. 8 illustrates a portion of the column S/H circuitry 254a or 254b illustrated in FIG. 7. As can be seen from FIG. 8, there is circuitry for the odd channel and separate circuitry for the even channel. The components connected to the odd channel include a crowbar switch 270o, two sample and hold switches 272o, 282o, two sample and hold capacitors 274o, 284o, two clamping switches 276o, 286o, two fine decode switches 278o, 288o, and two group decode switches 280o, 290o. The components connected to the even channel include a crowbar switch 270e, two sample and hold switches 272e, 282e, two sample and hold capacitors 274e, 284e, two clamping switches 276e, 286e, two fine decode switches 278e, 288e, and two group decode switches 280e, 290e.

The clamping switches 276o, 276e, 286o, 286e are used to place a clamp voltage VCL on one plate of the S/H capacitors 274o, 274e, 284o, 284e. S/H switches 272o, 272e in response to a sample and hold pixel control signal SHS are used to store analog pixel signals on S/H capacitors 274o, 274e. S/H switches 282o, 282e in response to a sample and hold reset control signal SHR are used to store analog reset signals on S/H capacitors 284o, 284e. The crowbar switches 270o, 270e are used to read out the signals stored in the S/H capacitors 274o, 284e, 274o, 284e. The fine decode switches 278o, 288e, 278o, 288e are closed in response to a fine decode control signal (when a single column address is being decoded). The group decode switches 280o, 290e, 280o, 290e are closed in response to a group decode control signal (when multiple column addresses are being decoded).

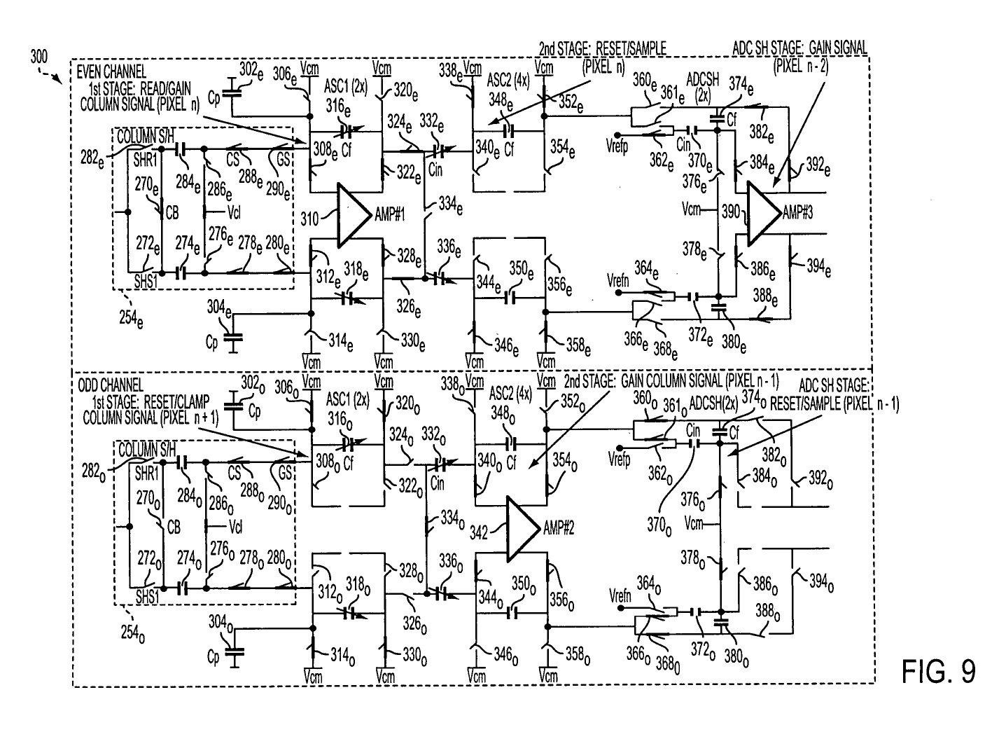

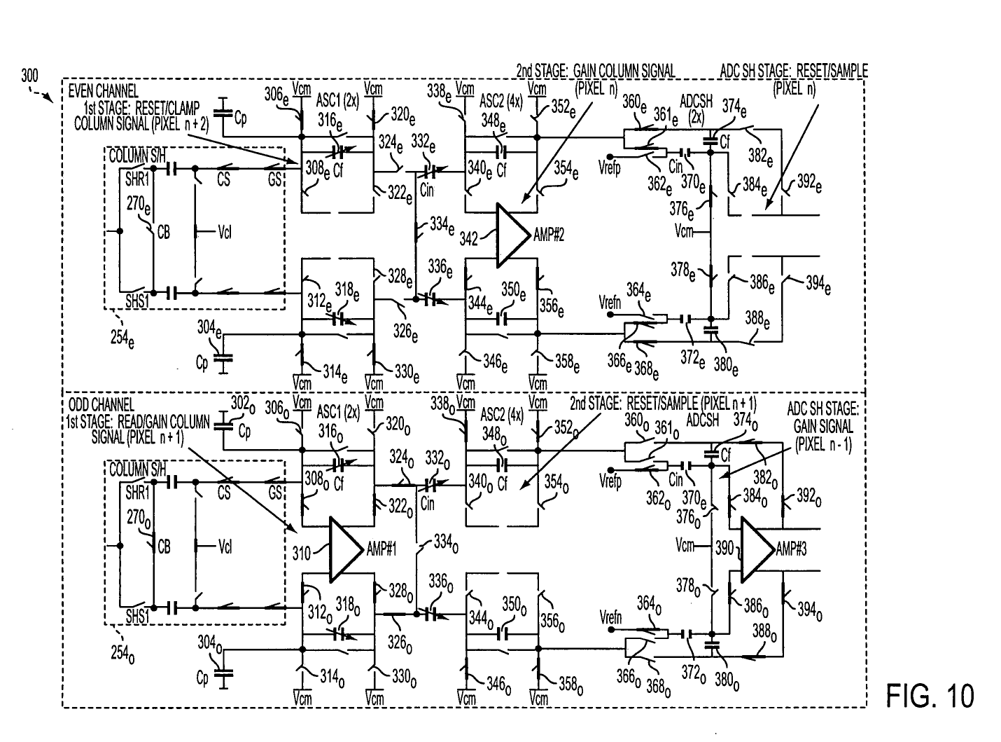

FIGS. 9-10 illustrate the components and operation of a readout chain 300 for imager 250. The illustrated chain 300 includes an even channel and an odd channel, which share amplifiers 310, 342, 390 during its two operational phases PHI1, PHI2. Connecting metal wiring that enables the amplifiers 310, 342, 390 to be shared is not shown to avoid cluttering FIGS. 9-10. Each channel includes three stages: stage 1 is a first analog signal chain ASC1, stage 2 is a second analog signal chain ASC2, and the third stage is an analog-to-digital sample and hold stage ADCSH.

The even channel is now described. Column sample and hold circuitry 254e is connected to the first analog signal chain ASC1. The illustrated column S/H circuitry 254e includes the components described above with respect to FIG. 8, but for a single channel (i.e., even channel). That is, the S/H circuitry 254e includes a crowbar switch 270e, two sample and hold switches 272e, 282e, two sample and hold capacitors 274e, 284e, two clamping switches 276e, 286e, two fine decode switches 278e, 288e, and two group decode switches 280e, 290e.

The first analog signal chain ASC1 includes parasitic capacitance 302e, 304e, switches 306e, 308e, 312e, 314e, 320e, 322e, 324e, 326e, 328e, 330e, amplifier 310, and two adjustable capacitors 316e, 318e. The first analog signal chain ASC1 is connected to the second analog signal chain ASC2.

The second analog signal chain ASC2 includes two adjustable capacitors 332e, 336e, eight switches 334e, 338e, 340e, 344e, 346e, 352e, 354e, 356e, 358e, amplifier 342 (shown as part of the odd channel), and two feedback capacitors 348e, 350e. The second analog signal chain ASC2 is connected to the analog-to-digital sample and hold stage ADCSH.

The analog-to-digital sample and hold stage ADCSH includes switches 360e, 361e, 362e, 364e, 366e, 368e, 376e, 378e, 382e, 384e, 386e, 388e, 392e, 394e, amplifier 390, two input capacitors 370e, 372e and two feedback capacitors 374e, 380e.

The odd channel has the same configuration and is now described. Column sample and hold circuitry 254o is connected to the first analog signal chain ASC1. The illustrated column S/H circuitry 254o includes the components described above with respect to FIG. 8, but for a single channel (i.e., even channel). That is, the S/H circuitry includes a crowbar switch 270o, two sample and hold switches 272o, 282o, two sample and hold capacitors 274o, 284o, two clamping switches 276o, 286o, two fine decode switches 278o, 288o, and two group decode switches 280o, 290o.

The first analog signal chain ASC1 includes parasitic capacitance 302o, 304o, switches 306o, 308o, 312o, 314o, 320o, 322o, 324o, 326o, 328o, 330o, amplifier 310 (shown as part of the even channel), and two adjustable capacitors 316o, 318o. The first analog signal chain ASC1 is connected to the second analog signal chain ASC2.

The second analog signal chain ASC2 includes two adjustable capacitors 332o, 336o, switches 334o, 338o, 340o, 344o, 346o, 352o, 354o, 356o, 358o, amplifier 342, and two feedback capacitors 348o, 350o. The second analog signal chain ASC2 is connected to the analog-to-digital sample and hold stage ADCSH.

The analog-to-digital sample and hold stage ADCSH includes switches 360o, 361o, 362o, 364o, 366o, 368o, 376o, 378o, 382o, 384o, 386o, 388o, 392o, 394o, amplifier 390, two input capacitors 370o, 372o and two feedback capacitors 374o, 380o.

During the first phase PHI1 of operation, the even channel operates on a current pixel n and prior pixel n−2, while the odd channel operates on a next pixel n+1 and prior pixel n−1.

For the odd channel, the first analog signal chain ASC1 undergoes a reset/clamp operation. During this time, amplifier 310 is not needed and is therefore switched out of the odd channel (since it is being used in the even channel, described below in more detail). Switches 306o, 314o, 320o and 330o are closed, connecting the odd channel's first analog signal chain ASC1 to the common mode voltage Vcm.

At this time, the second analog signal chain ASC2 is applying a gain to prior pixel n−1's signals. To do so, switches 340o, 344o, 354o and 356o are closed forming a completed first feedback path through switch 354o, capacitor 348o and switch 340o to a first input of amplifier 342 and a completed second feedback path through switch 356o, capacitor 350o and switch 344o to a second input of amplifier 342. Also during this time, the analog-to-digital sample and hold stage ADCSH undergoes a reset/sample operation on pixel n−1. This is accomplished by closing switches 360o, 361o, 366o, 368o. During this time, amplifier 390 is not needed and is therefore switched out of the odd channel (since it is being used in the even channel, described below in more detail).

In the even channel, the first and second analog signal chains ASC1, ASC2 operate on the current pixel n, while the analog-to-digital S/H stage ADCSH operates on prior pixel n−2. The first analog signal chain ASC1 inputs two analog pixel signals from the S/H circuitry 254e (i.e., crowbar switch 270e is closed) and applies a gain to these signals. During this time, amplifier 310 is active. Switches 308e, 312e, 322e, 328e, 324e, 326e are closed. A first feedback path through switch 322e, capacitor 316e and switch 308e to a first input of amplifier 310 is formed. A second feedback path through switch 328e, capacitor 318e and switch 312e to a second input of amplifier 310 is also formed. The outputs of the first amplifier are connected to the second analog signal chain ASC2 through closed switches 324e, 326e.

At this time, the second analog signal chain ASC2 is undergoing a reset/sample operation for pixel n. Since amplifier 342 would be idle, it is connected to the odd channel (described above). Switches 338e, 346e, 352e, 358e are closed connecting the second analog signal chain ASC2 to the common mode voltage Vcm.

Also during this time, the analog-to-digital sample and hold stage ADCSH applies a gain to prior pixel n−2. The gain is set by closing switches 362e connected to a positive reference voltage Vrefp, closing switch 364e connected to a negative reference voltage Vrefn, opening switches 360e, 361e, 366e, 368e, 376e, 378e and closing switches 382e, 384e, 386e, 388e, 392e, 394e.

During the second phase PHI2 of operation, in the even channel, the first analog signal chain ASC1 undergoes a reset/clamp operation for a subsequent pixel n+2. During this time, amplifier 310 is not needed and is therefore switched out. Switches 306e, 314e, 320e and 330e are closed, connecting the even channel's first analog signal chain ASC1 to the common mode voltage Vcm.

At this time, the second analog signal chain ASC2 is applying a gain to pixel n's signals. To do so, switches 340e, 344e, 354e and 356e are closed forming a completed first feedback path through switch 354e, capacitor 348e and switch 340e to a first input of amplifier 342 and a completed second feedback path through switch 356e, capacitor 350e and switch 344e to a second input of amplifier 342. Also during this time, the analog-to-digital sample and hold stage ADCSH undergoes a reset/sample operation on pixel n. This is accomplished by closing switches 360e, 361e, 366e, 368e. During this time, amplifier 390 is not needed and is therefore switched out.

In the odd channel, the first and second analog signal chains ASC1, ASC2 operate on pixel n+1, while the analog-to-digital S/H stage ADCSH operates on prior pixel n−1. The first analog signal chain ASC1 inputs two analog pixel signals from the S/H circuitry 254o (i.e., crowbar switch 270o is closed) and applies a gain to these signals. During this time, amplifier 310 is active. Switches 308o, 312o, 322o, 328o, 324o, 326o are closed. A first feedback path through switch 322o, capacitor 316o and switch 308o to a first input of amplifier 310 is formed. A second feedback path through switch 328o, capacitor 318o and switch 312o to a second input of amplifier 310 is also formed. The outputs of the first amplifier are connected to the second analog signal chain ASC2 through closed switches 324o, 326o.

At this time, the second analog signal chain ASC2 is undergoing a reset/sample operation for pixel n+1. Since amplifier 342 would be idle, it is connected to the even channel (described above). Switches 338o, 346o, 352o, 358o are closed connecting the second analog signal chain ASC2 to the common mode voltage Vcm.

Also during this time, the analog-to-digital sample and hold stage ADCSH applies a gain to prior pixel n−1. The gain is set by closing switches 362o connected to the positive reference voltage Vrefp, closing switch 364o connected to the negative reference voltage Vrefn, opening switches 360o, 361o, 366o, 368o, 376o, 378o and closing switches 382o, 384o, 386o, 388o, 392o, 394o.

In operation, the circuitry of the green and red/blue ports are operated at the clock rate (1×). The channels, on the other hand, run at half the clock speed (1/2×). One of the two channels provides analog signals to the ports every clock cycle. With this pipelined configuration operating in parallel, the effective conversion rate of the imager is now 96 mega-samples/second, which is two times the master clock speed.

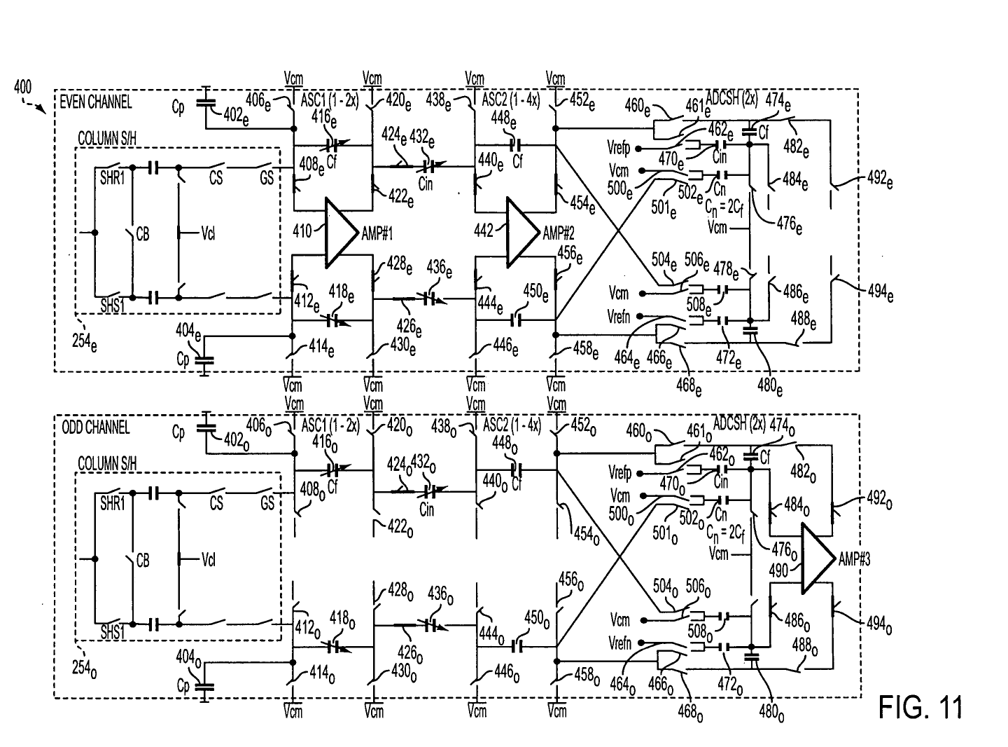

The inventor has determined, in addition, that it is also desirable to operate the gain stages (i.e., ASC1, ASC2) of the channels at the 1/2× rate (i.e., 1/2 master clock rate) to reduce readout noise in the imager 250. Accordingly, FIG. 11 illustrates a readout chain 400 constructed in accordance with an embodiment of the invention. As is described below in more detail, the chain 400 stores the reset level (including offsets and noise) from the gain stage “auto-zero” or reset step onto a capacitor and subtracts the reset level from the subsequently amplified column signal.

In the illustrated embodiment, a slight modification is made to the serial readout chains 300 described above by adding noise storage capacitors 502e, 502o, 508e, 508o to the ADCSH stage front end circuitry. Because the ADCSH stage front end applies a gain of 2 to the signal from the ASC2 stage, the noise signal must also have a gain of 2 applied to it because it is subtracted from the signal. In the illustrated embodiment, the noise storage capacitors 502e, 502o, 508e, 508o must be two-times larger than the feedback capacitors 474e, 474o, 480e, 480o.

To implement the invention, the two amplifier stages ASC1, ASC2 should be operated in a cascaded gain configuration rather than the pipelining configuration described above. This produces the lowest noise possible because the noise is sampled only once during the gain stages ASC1, ASC2 rather than multiple times at the output of each ASC stage that's possible in a pipeline gain configuration. The bandwidth of the amplifiers is increased by approximately 8% to settle within the same time as the pipelined gain approach (assuming that chain 300 settles 12 bits or 8.5 time constants).

In the particular design implementation, noise calculations show that the signal chain readout floor is reduced to 280 μV at 1× gain (compared to 635 μV for chain 300) and to 115 μV at 8× gain (compared to 205 μV). Power is slightly increased by about 8 mW.

The illustrated chain 400 includes an even channel and an odd channel, which share amplifiers 410, 442, 490 during its operational phases (described below). Connecting metal wiring that enables the amplifiers 410, 442, 490 to be shared is not shown to avoid cluttering the Figures. Each channel includes three stages: stage 1 is a first analog signal chain ASC1, stage 2 is a second analog signal chain ASC2, and the third stage is an analog-to-digital sample and hold stage ADCSH.

The even channel is now described. Column sample and hold circuitry 254e is connected to the first analog signal chain ASC1. The illustrated column S/H circuitry 254e includes the components described above with respect to FIGS. 9 and 10.

The first analog signal chain ASC1 includes parasitic capacitance 402e, 404e, switches 406e, 408e, 412e, 414e, 420e, 422e, 424e, 426e, 428e, 430e, amplifier 410, and two adjustable capacitors 416e, 418e. The first analog signal chain ASC1 is connected to the second analog signal chain ASC2.

The second analog signal chain ASC2 includes two adjustable capacitors 432e, 436e, switches 438e, 440e, 444e, 446e, 452e, 454e, 456e, 458e, amplifier 442, and two feedback capacitors 448e, 450e. The second analog signal chain ASC2 is connected to the analog-to-digital sample and hold stage ADCSH. The first and second analog signal chains ASC1, ASC2 are cascaded, not pipelined.

The analog-to-digital sample and hold stage ADCSH includes switches 460e, 461e, 462e, 500e, 501e, 504e, 506e, 464e, 466e, 468e, 476e, 478e, 482e, 484e, 486e, 488e, 492e, 494e, amplifier 490 (not shown, but in some operations amplifier 490 will be part of this stage), two input capacitors 470e, 472e, two feedback capacitors 474e, 480e, and the noise storage capacitors 502e, 508e.

The odd channel has the same configuration and is now described. Column sample and hold circuitry 254o is connected to the first analog signal chain ASC1. The illustrated column S/H circuitry 254o includes the components described above with respect to FIGS. 9 and 10.

The first analog signal chain ASC1 includes parasitic capacitance 402o, 404o, ten switches 406o, 408o, 412o, 414o, 420o, 422o, 424o, 426o, 428o, 430o, amplifier 410 (not shown, but in some operations amplifier 410 will be part of this stage), and two adjustable capacitors 416o, 418o. The first analog signal chain ASC1 is connected to the second analog signal chain ASC2.

The second analog signal chain ASC2 includes two adjustable capacitors 432o, 436o, eight switches 438o, 440o, 444o, 446o, 452o, 454o, 456o, 458o, amplifier 442 (not shown, but in some operations amplifier 442 will be part of this stage), and two feedback capacitors 448o, 450o. The second analog signal chain ASC2 is connected to the analog-to-digital sample and hold stage ADCSH. The first and second analog signal chains ASC1, ASC2 are cascaded, not pipelined.

The analog-to-digital sample and hold stage ADCSH includes switches 460o, 461o, 462o, 500o, 501o, 504o, 506o, 464o, 466o, 468o, 476o, 478o, 482o, 484o, 486o, 488o, 492o, 494o, amplifier 490, two input capacitors 470o, 472o, two feedback capacitors 474o, 480o, and the noise storage capacitors 502o, 508o.

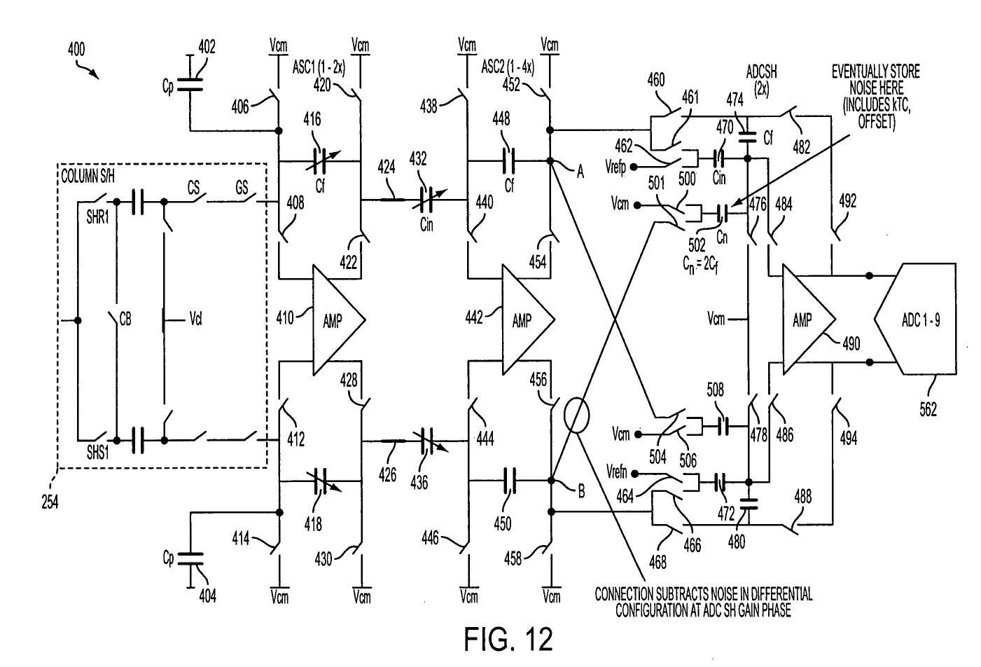

FIG. 12 illustrates a portion of the FIG. 11 readout chain 400, which is used herein to describe the operations and benefits of the illustrated embodiment of the invention. The chain 400 illustrates only one of the channels illustrated in FIG. 11 (as such, the designations “e” and “o” are not used). In addition, all shared amplifiers 410, 442, 490 are shown. In the illustrated chain 400, and as is described below in more detail, there is a cross-coupled connection between the second analog signal chain ASC2 and the noise storage capacitors 502, 508. Specifically, there is a first connection from point A to noise storage capacitor 508 (via switch 504) and connection from point B to noise storage capacitor 502 (via switch 501). In operation, noise stored in the noise storage capacitors 502, 508 is subtracted out of the circuit in the analog-to-digital sample and hold stage ADCSH when switches 501, 504 are closed. Thus, the chain 400 includes a clamped capacitor noise rejection circuit.

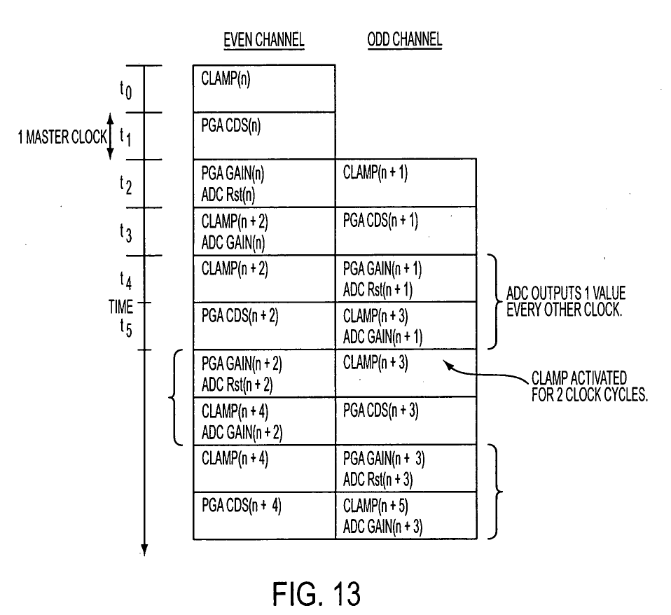

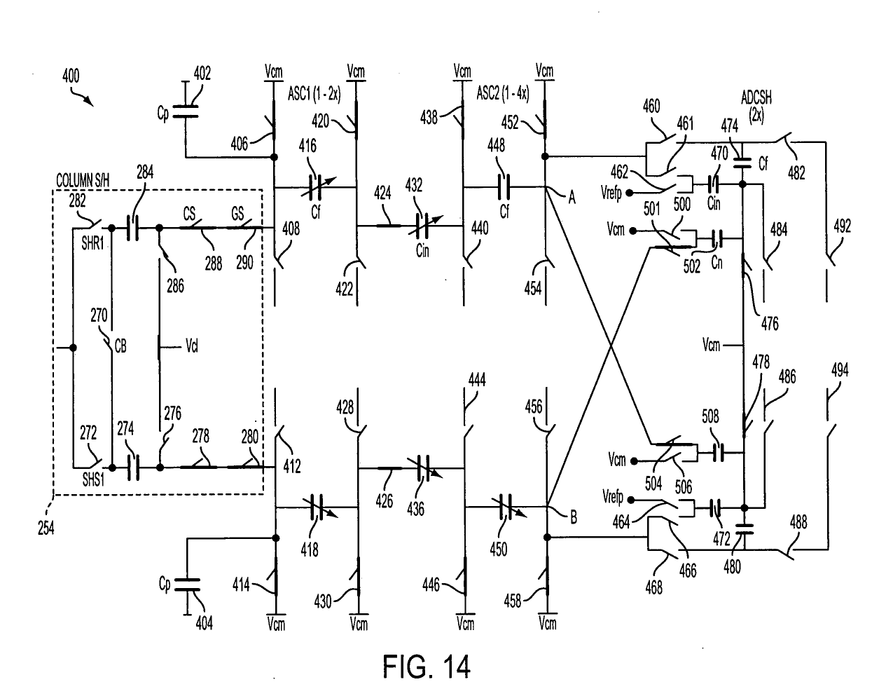

FIGS. 13-17 illustrate the components and operation of the chain 400 of the embodiment during various phases of operation. Initially (t0), the even channel undergoes a PGA reset/clamp phase of operation (FIG. 14) where the gain readout bus and capacitors are clamped to the common mode voltage Vcm for two clock cycles. Time t0 of FIG. 13 illustrates the second clock cycle of this phase.

The odd channel is processing the current pixel n. During this time, the amplifiers 410, 442, 490 are not needed in the odd channel (accordingly, they are not shown in FIG. 14). Switches 406, 414, 420, 430, 438, 446, 452, 458 are closed, connecting the first and second analog signal chains ASC1, ASC2 to the common mode voltage Vcm. Switches 424, 426 are also closed. At this time, switches 476, 478, 501, 504 are closed in the analog-to-digital sample and hold stage ADCSH.

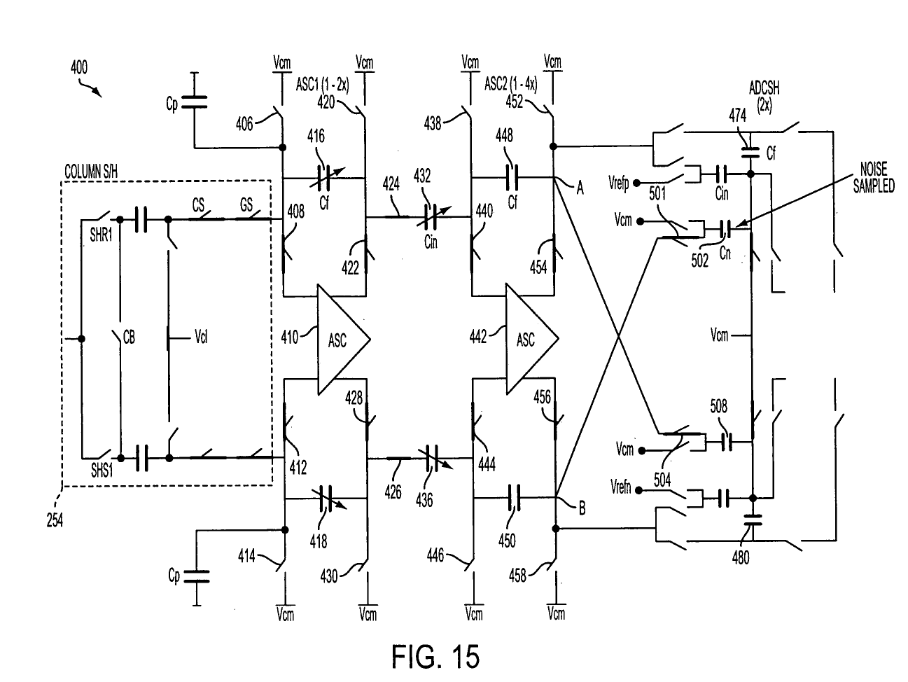

At t1, the even channel undergoes a PGA CDS phase (FIG. 15) on the current pixel n. In the first analog signal chain ASC1, switches 406, 414, 420, 430 are opened, switches 408, 412, 422, 428 are closed. A first feedback path for amplifier 410 comprising switch 422, capacitor 416 and switch 408 is formed. A second feedback path for amplifier 410 comprising switch 428, capacitor 418 and switch 412 is also formed.

In the second analog signal chain ASC2, switches 438, 446, 452, 458 are opened and switches 440, 444, 454, 456 are closed. A first feedback path for amplifier 442 comprising switch 454, capacitor 448 and switch 440 is formed. A second feedback path for amplifier 442 comprising switch 456, capacitor 450 and switch 444 is also formed. Noise, including kTC noise from the cascaded gain stages, is now sampled onto the noise storage capacitors 502, 508. It is noted that the amplifier offset (including any “memory” from the amplifier input capacitance) is amplified and stored on the storage capacitors 502, 508. Thus, the capacitors must be two-times the size of the feedback capacitors 474, 480 to match the signal gain in the analog-to-digital sample and hold stage ADCSH.

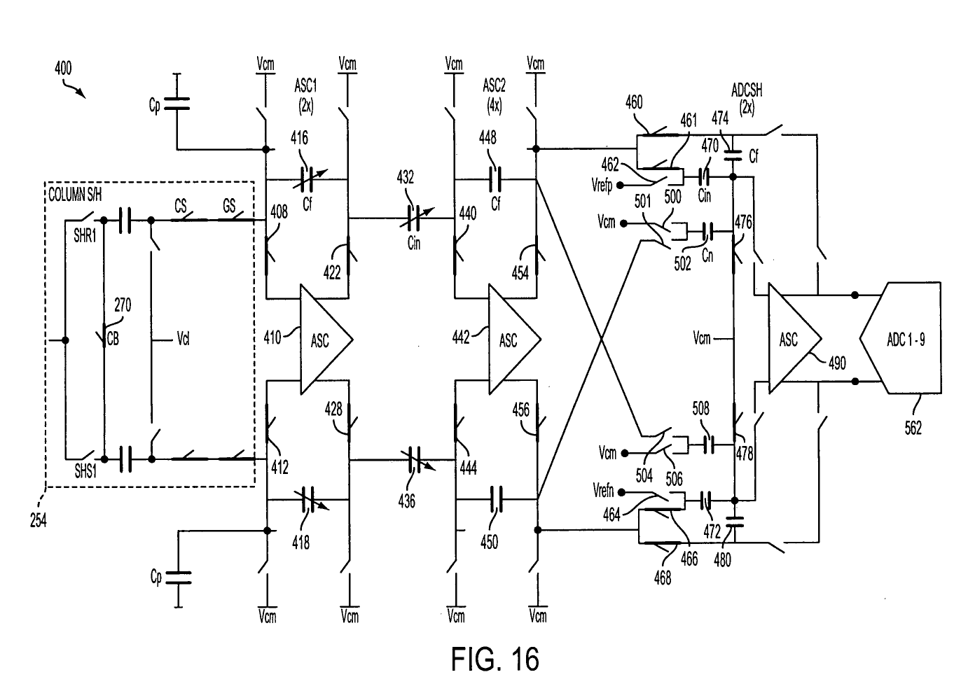

At t2 the even channel undergoes a PGA gain phase (FIG. 16) for pixel n (at the same time, the analog-to-digital sample and hold stage ADCSH is reset). The odd channel will undergo the reset/clamp phase for the next pixel n+1 (described above with respect to FIG. 14).

For the even channel, the first analog signal chain ASC1 inputs two analog pixel signals from the S/H circuitry 254 (i.e., crowbar switch 270 is closed) and applies a gain to these signals (using the feedback paths). The outputs of the first amplifier 410 are connected to the second analog signal chain ASC2. The second analog signal chain ASC2 also applies a gain to the input signals. These amplified signals are stored in capacitors 470, 472, 474, 480 (via switches 461, 466, 460, 468) in the analog-to-digital sample and hold stage ADCSH. In addition, switches 476, 478 are closed while switches 462, 500, 501, 464, 504, 506 are opened. During this phase, the remaining noise that is not removed is from the ASC1, ASC2 amplifier.

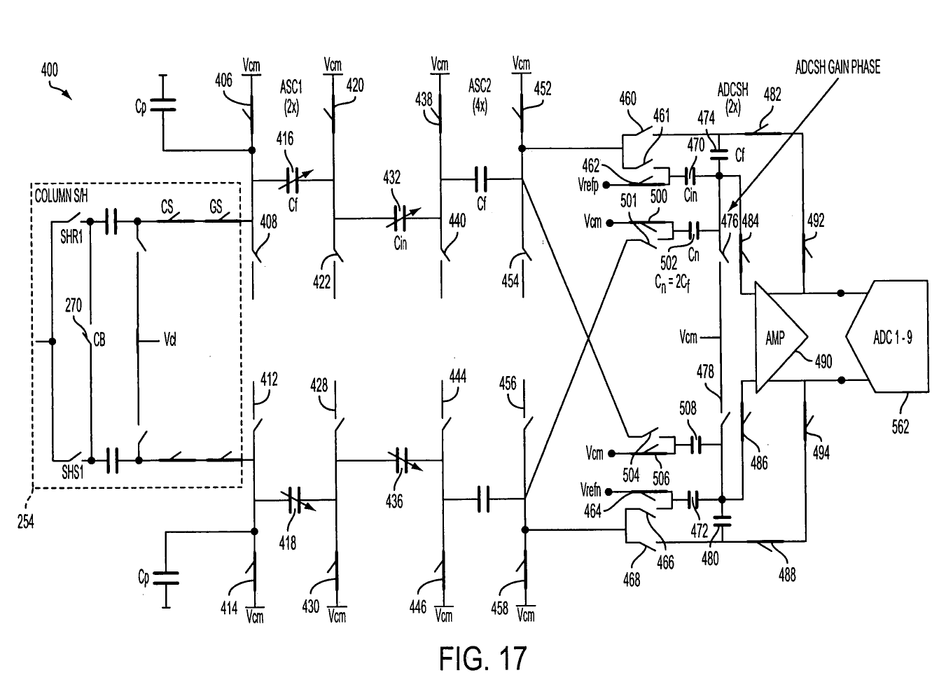

At time t3, the first and second analog signal chains ASC1, ASC2 of the odd channel undergo the first cycle of the reset/clamp phase for pixel n+2 while the analog-to-digital sample and hold stage ADCSH performs a gain operation on the stored signals for pixel n (FIG. 17). The odd channel will undergo the PGA CDS phase for pixel n+1 (described above with respect to FIG. 15).

For the even channel, switches 406, 414, 420, 430, 438, 446, 452, 458 are closed, connecting the first and second analog signal chains ASC1, ASC2 to the common mode voltage Vcm. Switches 408, 412, 422, 428, 440, 442 are opened because amplifiers 410, 442 are being used in the odd channel. In the analog-to-digital sample and hold stage ADCSH, switches 462, 500, 506, 464, 484, 486, 482, 488, 492, 494 are closed. The analog-to-digital sample and hold stage ADCSH outputs the signals to the ADC 562. During the analog-to-digital sample and hold stage ADCSH gain phase, noise from the column/PGA reset phases is removed by subtracting the noise from the signal. Amplifier offsets are also subtracted out.

At time t4, the even channel undergoes the second cycle of the reset/clamp phase for pixel n+2 (FIG. 14) while the odd channel undergoes the PGA gain/ADC reset phase for pixel n+1 (FIG. 16). At time t5, the even channel undergoes the PGA CDS phase for pixel n+2 (FIG. 15) while the odd channel undergoes the reset/clamp phase for pixel n+3 and the ADC gain phase for pixel n+1 (FIG. 17).

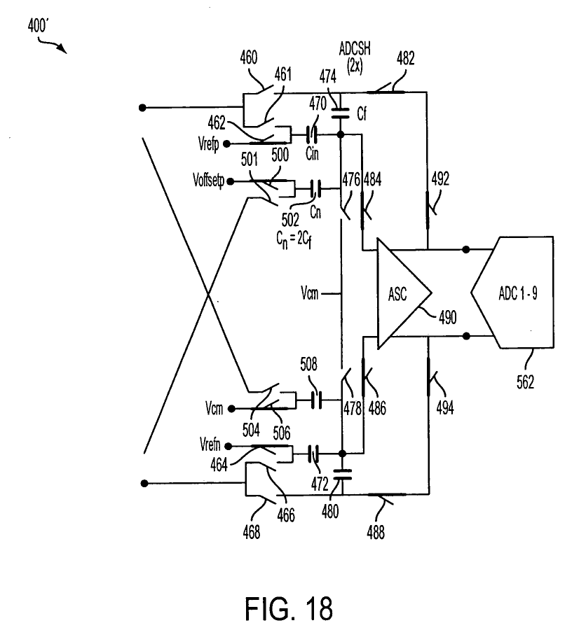

It should be appreciated that the noise can be stored on the noise storage capacitors 502, 508 or combined with the offset “calibration” capacitors (as shown in the chain 400′ of FIG. 18). In the chain 400′ of FIG. 18, switch 500 is connected to the analog-to-digital converter offset voltage Voffsetp instead of the common mode voltage Vcm. Although not shown, switch 506 is connected to the analog-to-digital converter offset voltage Voffsetn instead of the common mode voltage Vcm.

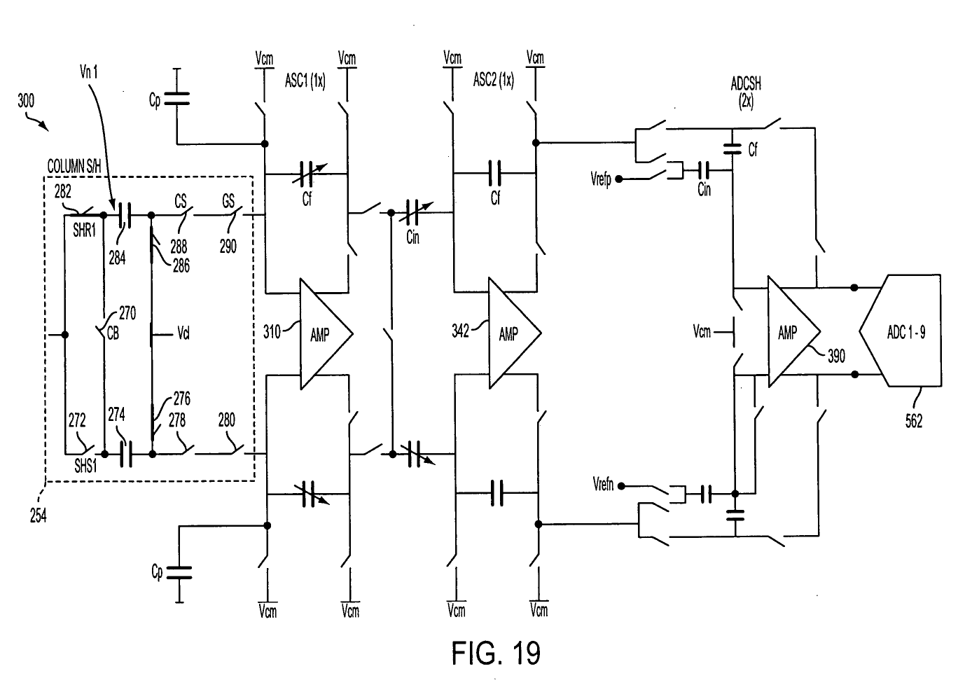

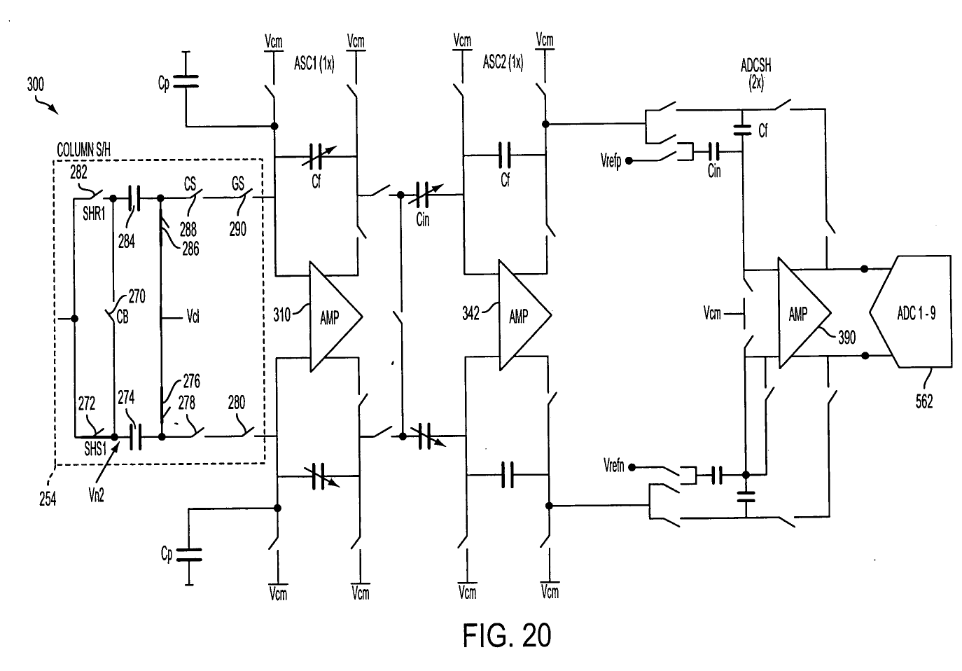

FIGS. 19-23 illustrate portions of readout circuit 300 for corresponding noise calculations and comparisons to the readout circuits 400, 400′ of the invention. With reference to FIG. 19, during the pixel reset readout phase, in the S/H circuit 254 there is a first noise Vn1=(kT/C)^{1/2}=45 μV when capacitor 284=2 pF. With reference to FIG. 20, during the pixel signal readout phase, in the S/H circuit 254 there is a second noise Vn2=(kT/C)^{1/2}=45 μV when capacitor 274=2 pF.

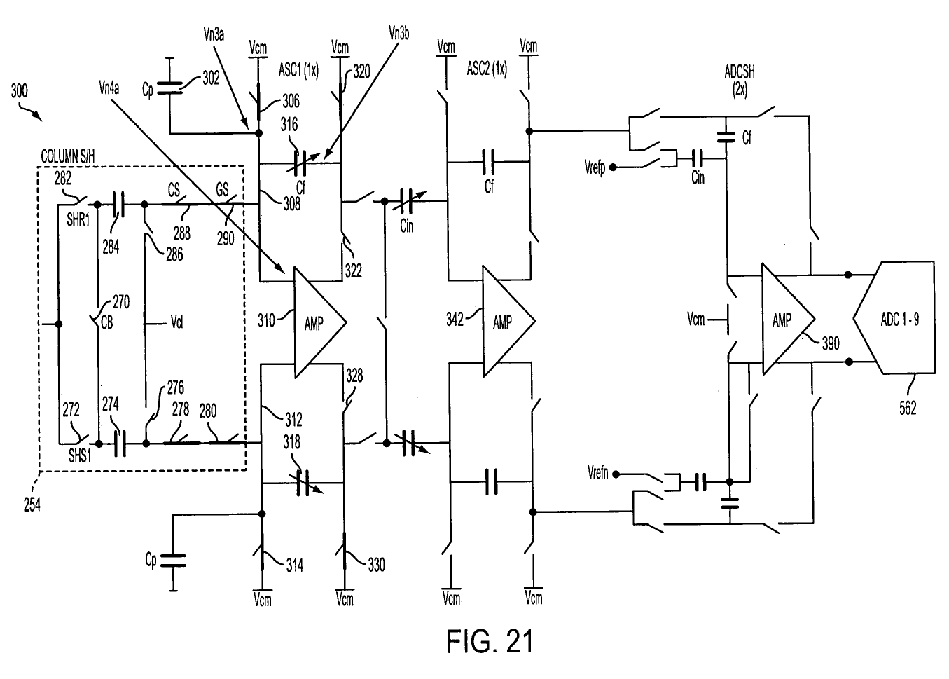

With reference to FIG. 21, during the column readout reset/clamp phase, there is a noise Vn3a=(kT/C)^{1/2}=26 μV when the parasitic capacitance 302=4.8 pF and the capacitance of the amplifier is 1.2 pF. A noise Vn3b=(kT/C)^{1/2}=45 μV when feedback capacitor 316=2 pF. Amplifier thermal noise Vn4a=[(1.4 nV)²×200 MHz×3.14/2]^{1/2}=23 μV.

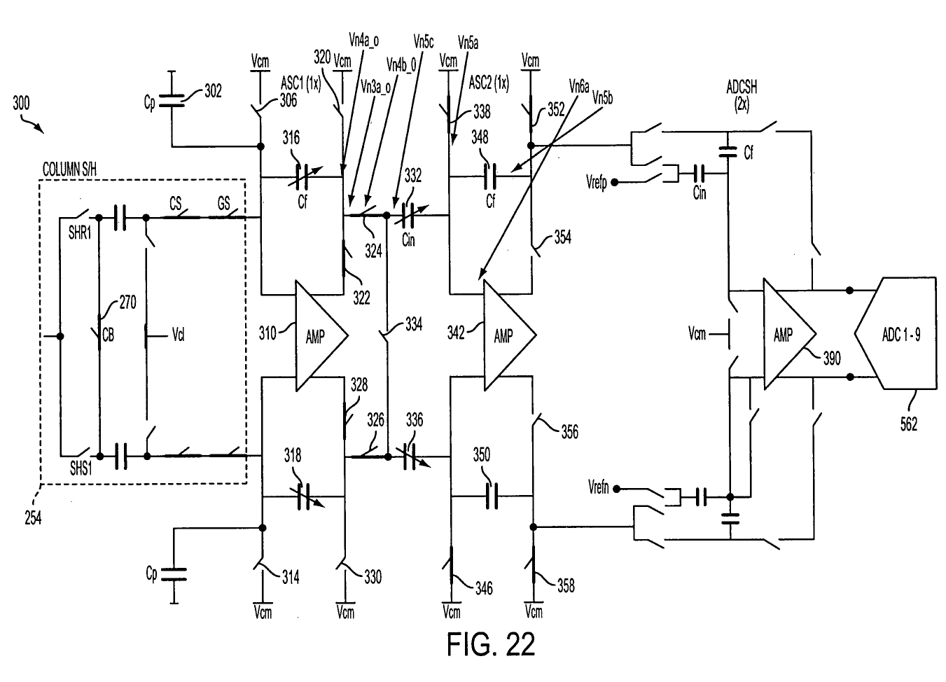

With reference to FIG. 22, during the column readout first gain phase, there is a noise Vn3a_o=Vn3a×1/B=26 μV×3=78 μV (for 1× gain: capacitor 316=2 pF; capacitor 302=4.8 pF; capacitance of amplifier 310 (i.e., “Copamp”)=1.2 pF, where 1/B (kTC component of capacitor 302, amplifier 310)=(4.8 pF+1.2 pF)/2 pF=3)). Amplifier thermal noise Vn4a_o=Vn4×1/B=23 uV×4.0=92 uV (for 1× gain: Cf=2 pF; Cp=4.8 pF, Copamp=1.2 pF; where 1/Bt=(2 pF+4.8 pF+1.2 pF)/2 pF=4.0). Noise Vn4b_o=[(1.3 nV)2×100 MHz×3.14/2]1/2×5=16 V×5=80 μV (from op amp thermal noise during gain: gm (op amp input)=10 ms; gm (op amp load)=5.2 ms; where bandwidth (BW)=100 MHz, 1/B=(2 pF+4.8 pF+2 pF+1.2 pF)/2 pF=5). Other noise calculations include Vn5a=(kT/C)1/2=66 μV for Cp=200 fF, Copamp=750 fF, C=950 fpF; Vn5b=(kT/C)1/2=144 μV for capacitor 348=200 fF; Vn5c=(kT/C)1/2=144 μV for capacitor 332=200 fF; and Vn6a=[(1.3 nV)2×200 MHz×3.14/2]1/2=23 μV (for op amp thermal noise during reset: gm (op amp input)=10 ms; gm (op amp load)=5.2 ms; circuit bandwidth=200 MHz).

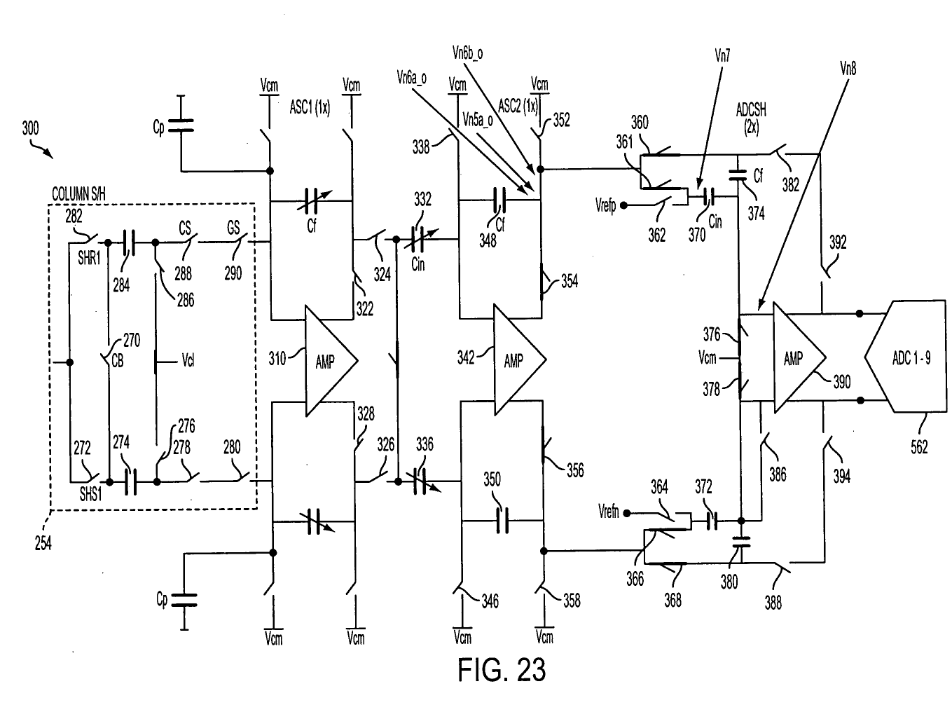

With reference to FIG. 23, during the column readout second gain phase, there is a noise Vn5a_o=Vn5a×1/B=66 μV×4.75=314 μV (for 1× gain: capacitor 348=200 fF; Cp=200 fF, capacitance of amplifier 342 (“Copamp”)=750 fF; 1/B (KTC component stored on Cp & Copamp)=(200 fF+750 pF)/200 fF=4.75); Vn6a_o=Vn6×1/B=23 μV×6.75=155 μV for capacitor 332=200 fF, capacitor 348=200 fF, Cp=200 fF, Copamp=750 fF and where 1/B=(200 fF+200 fF+200 fF+750 pF)/200 fF=6.75; Vn6b_o=[(1.3 nV)2×100 MHz×3.14/2]1/2×1/B=16 μV×6.75=108 μV (for op amp thermal noise during gain: gm (op amp input)=10 mS; gm (op amp load)=5.2 ms; circuit bandwidth=100 MHz); Vn7=(kT/C)1/2=64 μV for capacitor 374=500 fF, capacitor 370=500 fF and C=1.0 pF; and Vn8=[(1.3 nV)2×200 MHz×3.14/2]1/2=23 μV (for op amp thermal noise: gm (op amp input)=10 mS; gm (op amp load)=5.2 ms; circuit bandwidth=200 MHz).

Column readout total noise for 1× gain, therefore would be: Vn² (@input)=((Vn1)²×2=(45 μV×1.41)²=(64 μV)²)+((Vn3a_o)²×2/G1²=(78 μV×1.41)²=(110 μV)²)+((Vn3b)²×2/G1²=(45 μV×1.41)²=(64 μV)²)+((Vn4a_o)²×2/G1²=(92 μV×1.41)²=(130 μV)²)+((Vn4b_o)²×2/G1²=(80 μV×1.41)²=(113 μV)²)+((Vn5a_o)²×2/(G1×G2)²=(314 μV×1.41)²=(443 μV)²)+((Vn5b)²×2/(G1×G2)²=(144 μV×1.41)²=(203 μV)²)+((Vn5c)²×2/G1²=(144 μV×1.41)²=(203 μV)²)+((Vn6a_o)²×2/(G1×G2)²=(155 μV×1.41)²=(218 μV)²)+((Vn6b_o)²×2/(G1×G2)²=(108 μV×1.41)²=(152 μV)²)+((Vn7)²×2/(G1×G2)²=(64 μV×1.41)²=(90 μV)²). With G1 and G2=1, Vn=638 μV. For G1=2, G2=4 (i.e., total gain is 8×), Vn=205 μV.

Noise calculations for the readout chain 400 of the invention would be: Vn² (@input)=((Vn1)²×2=(45 μV×1.41)²=(64 μV)²)+((Vn3a_o)²×2/G1²=0²)+((Vn3b)²×2/G1²=0²)+((Vn4a_o)²×2/G1²=(92 μV×1.41)²=(90 μV)²)+((Vn4b_o)²×2/G1²=(80 μV×1.41)²=(113 μV)²)+((Vn5a_o)²×2/(G1×G2)²=0²)+((Vn5b)²×2/(G1×G2)²=0²)+((Vn5c)²×2/G1²=0²+((Vn6a_o)²×2/(G1×G2)²=(155 μV×1.41)²=(152 μV)²)+((Vn6b_o)²×2/(G1×G2)²=(108 μV×1.41)²=(152 μV)²)+((Vn7)²×2/(G1×G2)²=(64 μV×1.41)²=(90 μV)²). With G1 and G2=1, Vn=282 μV. For G1=2, G2=4 (i.e., total gain is 8×), Vn=113 μV.

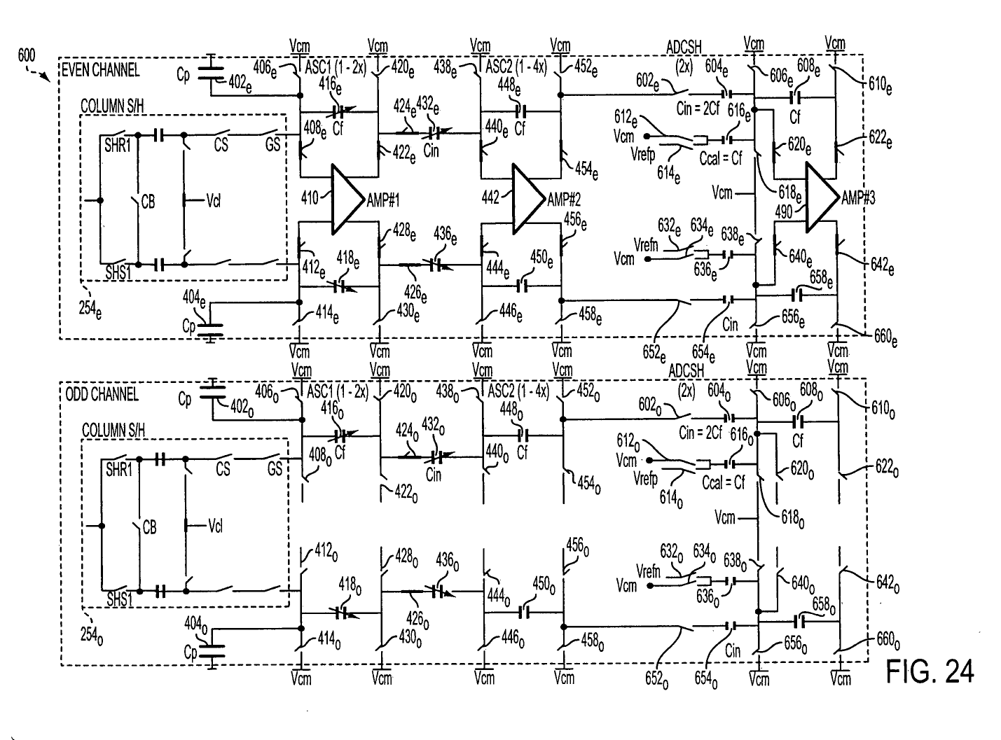

FIG. 24 illustrates a readout chain 600 constructed in accordance with another embodiment of the invention. In the illustrated embodiment, the gain stages ASC1, ASC2 and the analog-to-digital sample and hold stage ADCSH are cascaded. A true correlated double sampling CDS procedure is performed prior to the gain phases by clamping the clamped/reset voltage level of the gain amplifiers on the front end input capacitors of the analog-to-digital sample and hold stage ADCSH. As is described in more detail below, the timing of the circuitry reduces the signal chain noise. Power is slightly increased (approximately 14%). Noise calculations show that the signal chain readout floor is reduced to 220 μV at 1× gain (compared to 635 μV for chain 300) and to 100 μV at 8× gain (compared to 205 μV).

The illustrated chain 600 includes an even channel and an odd channel, which share amplifiers 410, 442, 490 during its operational phases (described below). Circuitry that enables the amplifiers 410, 442, 490 to be shared is not shown to avoid cluttering the Figures. Each channel includes three stages: stage 1 is a first analog signal chain ASC1, stage 2 is a second analog signal chain ASC2, and the third stage is an analog-to-digital sample and hold stage ADCSH.

The even channel is now described. Column sample and hold circuitry 254e is connected to the first analog signal chain ASC1. The illustrated column S/H circuitry 254e includes the components described above with respect to FIGS. 9 and 10.

The first analog signal chain ASC1 includes parasitic capacitance 402e, 404e, switches 406e, 408e, 412e, 414e, 420e, 422e, 424e, 426e, 428e, 430e, amplifier 410, and two adjustable capacitors 416e, 418e. The first analog signal chain ASC1 is connected to the second analog signal chain ASC2.

The second analog signal chain ASC2 includes two adjustable capacitors 432e, 436e, switches 438e, 440e, 444e, 446e, 452e, 454e, 456e, 458e, amplifier 442, and two feedback capacitors 448e, 450e. The second analog signal chain ASC2 is connected to the analog-to-digital sample and hold stage ADCSH via switches 602e, 652e. The first and second analog signal chains ASC1, ASC2 are cascaded, not pipelined.

The analog-to-digital sample and hold stage ADCSH includes switches 602e, 606e, 610e, 612e, 614e, 618e, 620e, 622e, 632e, 634e, 638e, 640e, 642e, 652e, 656e, 660e, amplifier 490, and capacitors 604e, 608e, 616e, 636e, 654e, 658e. Input capacitors 604e, 654e input and store noise during the operation of the circuit 600.

The odd channel has the same configuration and is now described. Column sample and hold circuitry 254o is connected to the first analog signal chain ASC1. The illustrated column S/H circuitry 254o includes the components described above with respect to FIGS. 9 and 10.

The first analog signal chain ASC1 includes parasitic capacitance 402o, 404o, switches 406o, 408o, 412o, 414o, 420o, 422o, 424o, 426o, 428o, 430o, amplifier 410 (not shown, but in some operations amplifier 410 will be part of this stage), and two adjustable capacitors 416o, 418o. The first analog signal chain ASC1 is connected to the second analog signal chain ASC2.

The second analog signal chain ASC2 includes two adjustable capacitors 432o, 436o, switches 438o, 440o, 444o, 446o, 452o, 454o, 456o, 458o, amplifier 442 (not shown, but in some operations amplifier 442 will be part of this stage), and two feedback capacitors 448o, 450o. The second analog signal chain ASC2 is connected to the analog-to-digital sample and hold stage ADCSH. The second analog signal chain ASC2 is connected to the analog-to-digital sample and hold stage ADCSH via switches 602o, 652o. The first and second analog signal chains ASC1, ASC2 are cascaded, not pipelined.

The analog-to-digital sample and hold stage ADCSH includes switches 602o, 606o, 610o, 612o, 614o, 618o, 620o, 622o, 632o, 634o, 638o, 640o, 642o, 652o, 656o, 660o, amplifier 490 (not shown, but in some operations amplifier 490 will be part of this stage), and capacitors 604o, 608o, 616o, 636o, 654o, 658o. Input capacitors 604o, 654o input and store noise during the operation of the circuit 600.

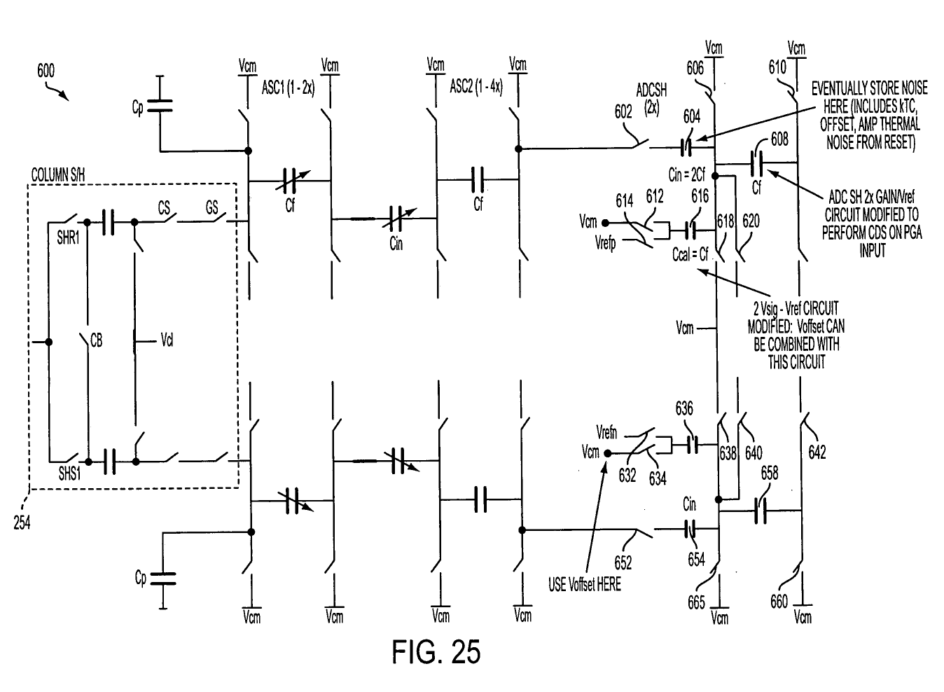

FIG. 25 illustrates a portion of the FIG. 24 readout chain 600, which is used herein to describe the operations and benefits of the illustrated embodiment of the invention. The chain 600 illustrates only one of the channels illustrated in FIG. 24 (as such, the designations “e” and “o” are not used).

As shown in FIG. 25, capacitors 604, 654 will eventually store kTC, offset and amplifier thermal noise from a reset operational phase. The analog-to-digital sample and hold stage ADCSH is modified to perform a CDS on the signals received from the gain stages ASC1, ASC2 (at capacitors 608, 658). Voffset can be combined at capacitors 616, 636.

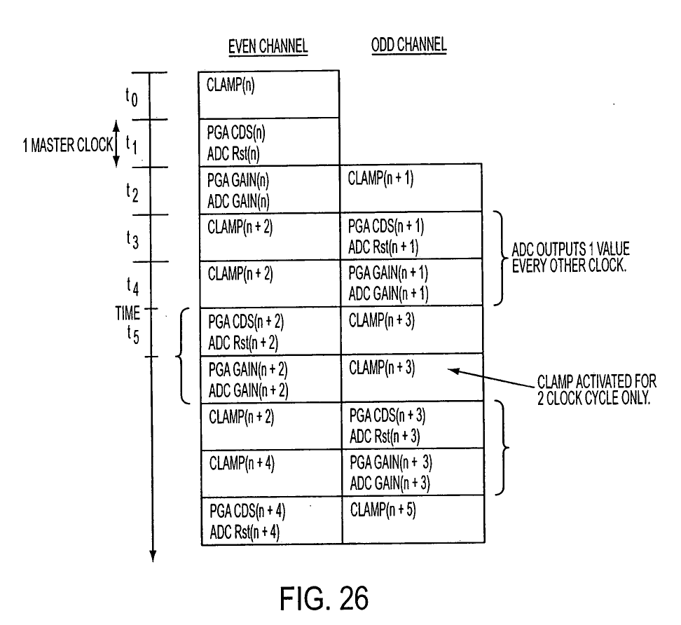

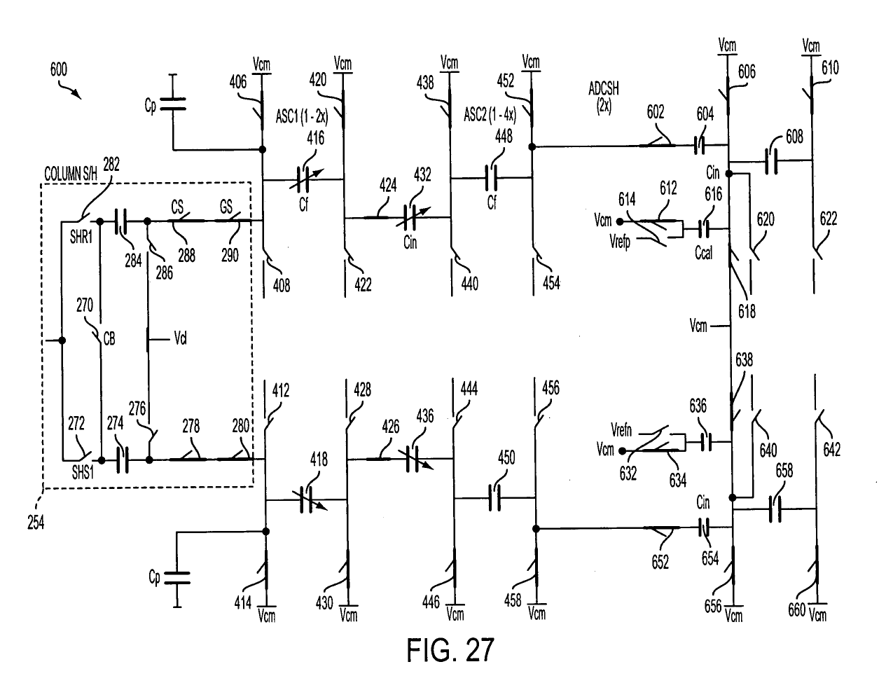

FIGS. 26-29 illustrate the components and operation of the chain 600 of the embodiment during various phases of operation. Initially (t0), the even channel undergoes a PGA reset/clamp phase of operation (FIG. 27) where the gain readout bus and capacitors are clamped to the common mode voltage Vcm for two clock cycles. Time t0 of FIG. 26 illustrates the second clock cycle of this phase.

The odd channel is processing the current pixel n. During this time, the amplifiers 410, 442, 490 are not needed in the odd channel (accordingly, they are not shown in FIG. 27). Switches 406, 414, 420, 430, 438, 446, 452, 458 are closed, connecting the first and second analog signal chains ASC1, ASC2 to the common mode voltage Vcm. Switches 424, 426 are also closed. At this time, switches 602, 606, 610, 612, 618, 634, 638, 652, 656, 660 are closed in the analog-to-digital sample and hold stage ADCSH.

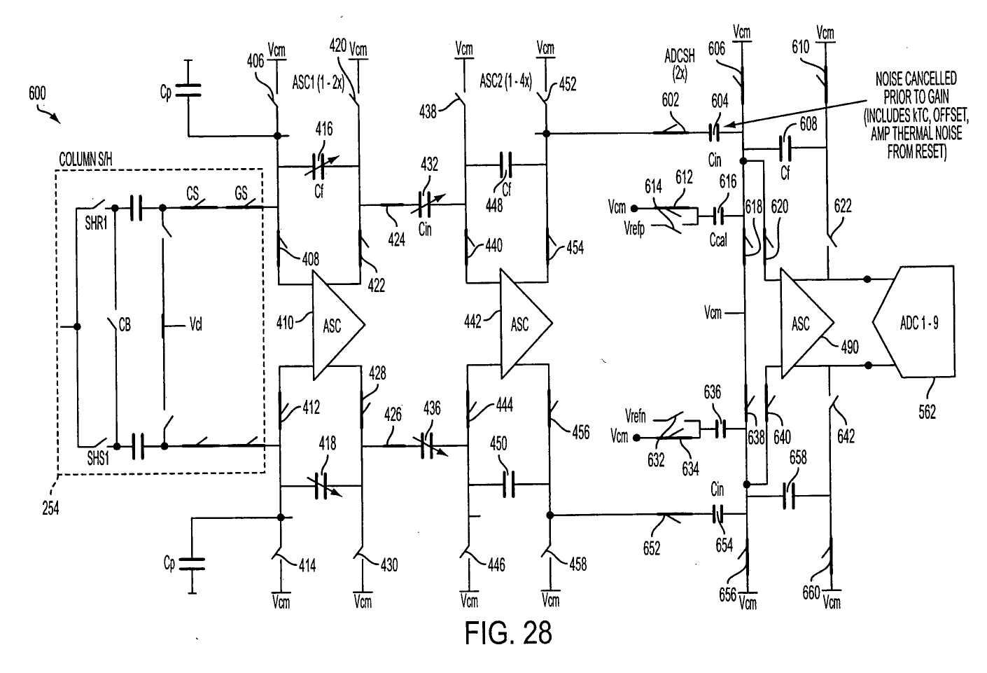

At t1, the even channel undergoes a PGA CDS/ADC reset phase (FIG. 28) on the current pixel n. In the first analog signal chain ASC1, switches 406, 414, 420, 424, 426, 430 are opened, switches 408, 412, 422, 428 are closed. A first feedback path for amplifier 410 comprising switch 422, capacitor 416 and switch 408 is formed. A second feedback path for amplifier 410 comprising switch 428, capacitor 418 and switch 412 is also formed.

In the second analog signal chain ASC2, switches 438, 446, 452, 458 are opened and switches 440, 444, 454, 456 are closed. A first feedback path for amplifier 442 comprising switch 454, capacitor 448 and switch 440 is formed. A second feedback path for amplifier 442 comprising switch 456, capacitor 450 and switch 444 is also formed. Noise, including kTC noise from the cascaded gain stages, is now sampled onto the noise storage capacitors 604, 654 (via switches 602, 652).

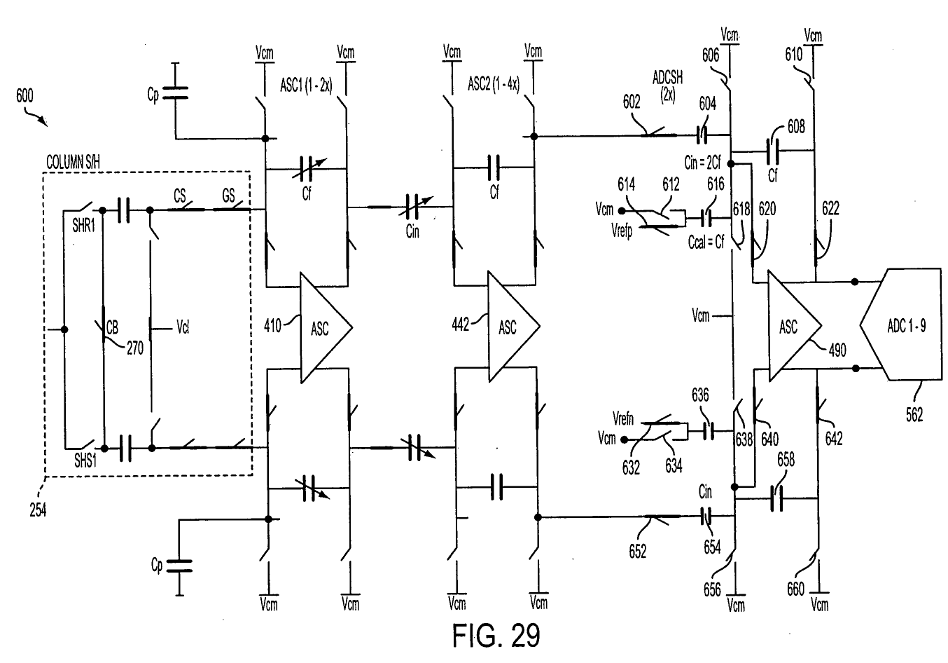

At t2 the even channel undergoes a PGA gain and ADC gain phase (FIG. 29) for pixel n. The odd channel will undergo the reset/clamp phase for the next pixel n+1 (described above with respect to FIG. 27).

For the even channel, the first analog signal chain ASC1 inputs two analog pixel signals from the S/H circuitry 254 (i.e., crowbar switch 270 is closed) and applies a gain to these signals (using the feedback paths). The outputs of the first amplifier 410 are connected to the second analog signal chain ASC2. The second analog signal chain ASC2 also applies a gain to the input signals. These amplified signals are applied to capacitors 604, 654 (via switches 602, 652) for further gain by the analog-to-digital sample and hold stage ADCSH while noise is not transferred from capacitors 604, 654 to the analog-to-digital sample and hold stage ADCSH output. In addition, switches 614, 620, 622, 632, 640, 642 are closed while switches 608, 610, 612, 618, 634, 638, 656, 660 are opened. During this phase, the remaining noise that is not removed is from amplifier thermal noise and analog-to-digital sample and hold stage ADCSH kTC noise that gets stored on input and feedback capacitors 604, 654. Amplifier offsets are amplified and stored on capacitors 604, 654.

At time t3, the first and second analog signal chains ASC1, ASC2 of the odd channel undergo the first cycle of the reset/clamp phase for pixel n+2 (FIG. 27). The odd channel will undergo the PGA CDS/ADC reset phase for pixel n+1 (described above with respect to FIG. 28). At time t4, the even channel undergoes the second cycle of the reset/clamp phase for pixel n+2 (FIG. 27) while the odd channel undergoes the PGA gain/ADC gain for pixel n+1 (FIG. 29). At time t5, the even channel undergoes the PGS CDS/ADC reset phase for pixel n+2 (FIG. 28) while the odd channel undergoes the reset/clamp phase for pixel n+3 (FIG. 27).

Noise calculations for the readout chain 400 of the invention would be: Vn² (@input)=((Vn1)²×2=(45 μV×1.41)²=(64 μV)²)+((Vn3a_o)²×2/G1²=0²)+((Vn3b)²×2/G1²=0²)+((Vn4a_o)²×2/G1²=0²)+((Vn4b_o)²×2/G1²=(80 μV×1.41)²=(113 μV)²)+((Vn5a_o)²×2/(G1×G2)²=0²)+((Vn5b)²×2/(G1×G2)²=0²)+((Vn5c)²×2/G1²=0²+((Vn6a_o)²×2/(G1×G2)²=0²)+((Vn6b_o)²×2/(G1×G2)²=(108 μV×1.41)²=(152 μV)²)+((Vn7)²×2/(G1×G2)²=(64 μV×1.41)²=(90 μV)²). With G1 and G2=1, Vn=219 μV. For G1=2, G2=4 (i.e., total gain is 8×), Vn=97 μV.

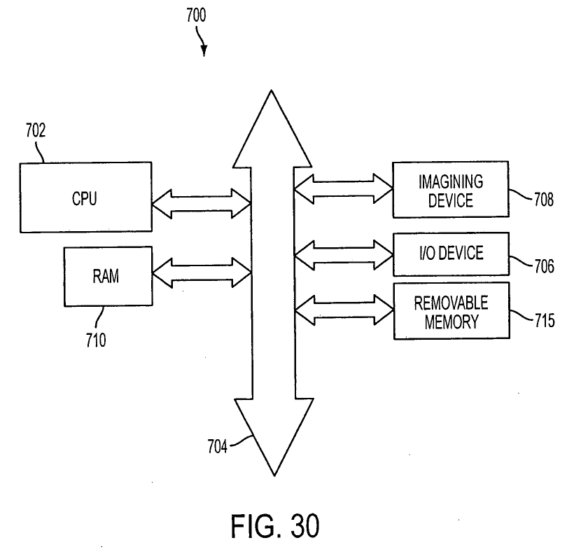

FIG. 30 shows system 700, a typical processor system modified to include an imaging device 708 constructed in accordance with an embodiment of the invention. The processor-based system 700 is exemplary of a system having digital circuits that could include image sensor devices. Without being limiting, such a system could include a computer system, camera system, scanner, machine vision, vehicle navigation, video phone, surveillance system, auto focus system, star tracker system, motion detection system, image stabilization system, and data compression system.

System 700, for example a camera system, generally comprises a central processing unit (CPU) 702, such as a microprocessor, that communicates with an input/output (I/O) device 706 over a bus 704. Imaging device 708 also communicates with the CPU 702 over the bus 704. The processor-based system 700 also includes random access memory (RAM) 710, and can include removable memory 715, such as flash memory, which also communicate with the CPU 702 over the bus 704. The imaging device 708 may be combined with a processor, such as a CPU, digital signal processor, or microprocessor, with or without memory storage on a single integrated circuit or on a different chip than the processor. The imaging device 708 may include one of the readout chains 400, 400′, 600 constructed in accordance with the invention.

It should be appreciated that other embodiments of the invention include a method of manufacturing the readout chains 400, 400′, 600 the invention. For example, in one exemplary embodiment, a method of fabricating readout chain for an imaging device. The method includes the steps of forming first and second stages coupled to receive pixel and reset signals from a column of pixels, where the first and second stages are cascaded. The method also includes forming a third stage coupled to the output of the second stage, the third stage comprising noise suppression circuitry for suppressing noise associated with said first and second stages.

The processes and devices described above illustrate preferred methods and typical devices of many that could be used and produced. The above description and drawings illustrate embodiments, which achieve the objects, features, and advantages of the present invention. However, it is not intended that the present invention be strictly limited to the above-described and illustrated embodiments. Any modification, though presently unforeseeable, of the present invention that comes within the spirit and scope of the following claims should be considered part of the present invention.

What is claimed as new and desired to be protected by Letters Patent of the United States is:

1. A readout chain for an imaging device, said readout chain comprising:
first and second stages coupled to receive pixel and reset signals from a column of pixels, said first and second stages being cascaded; and
a third stage coupled to the output of the second stage, said third stage comprising noise suppression circuitry for substantially suppressing noise associated with said first and second stages.

2. The readout chain of claim 1, wherein said first, second and third stages are cascaded.

3. The readout chain of claim 1, wherein said first and second stages are amplifier gain stages and said third stage is an analog-to-digital processing stage.

4. The readout chain of claim 1, wherein said noise suppression circuitry comprises:
a plurality of switches; and
a plurality of storage capacitors, said capacitors being switched into the third stage during an operational phase of the first and second stages.

5. The readout chain of claim 4, wherein said capacitors are switched into the third stage during a reset operational phase of the first and second stages.

6. The readout chain of claim 4, wherein said capacitors are switched into the third stage during a sampling operational phase of the first and second stages.

7. The readout chain of claim 4, wherein said capacitors are also used to supply offsets to an analog-to-digital converter.

8. The readout chain of claim 1, wherein the output of the second stage is cross-coupled with inputs of the third stage.

9. An imaging device comprising:
an array of pixels organized in to even and odd columns; and
a plurality of readout chains, each readout chain comprising:
sample and hold circuitry coupled to receive pixel and reset signals from a column of pixels;
first and second stages coupled to receive sample and held pixel and reset signals from said sample and hold circuitry, said first and second stages being cascaded; and
a third stage coupled to the output of the second stage, said third stage comprising noise suppression circuitry for substantially suppressing noise associated with said first and second stages.

10. The imaging device of claim 9, wherein said first, second and third stages are cascaded.

11. The imaging device of claim 9, wherein said first and second stages are amplifier gain stages and said third stage is an analog-to-digital processing stage.

12. The imaging device of claim 9, wherein said noise suppression circuitry comprises:
a plurality of switches; and
a plurality of storage capacitors, said capacitors being switched into the third stage during an operational phase of the first and second stages.

13. The imaging device of claim 12, wherein said capacitors are switched into the third stage during a reset operational phase of the first and second stages.

14. The imaging device of claim 12, wherein said capacitors are switched into the third stage during a sampling operational phase of the first and second stages.

15. The imaging device of claim 12, wherein said capacitors are also used to supply offsets to an analog-to-digital converter.

16. The imaging device of claim 9, wherein the output of the second stage is cross-coupled with inputs of the third stage.

17. A processor system comprising:
a processor; and
an imaging device coupled to said processor, said imaging device comprising an array of pixels organized in to even and odd columns, and a plurality of readout chains, each readout chain comprising:
sample and hold circuitry coupled to receive pixel and reset signals from a column of pixels;
first and second stages coupled to receive sample and held pixel and reset signals from said sample and hold circuitry, said first and second stages being cascaded; and
a third stage coupled to the output of the second stage, said third stage comprising noise suppression circuitry for substantially suppressing noise associated with said first and second stages.

18. The system of claim 17, wherein said first, second and third stages are cascaded.

19. The system of claim 17, wherein said first and second stages are amplifier gain stages and said third stage is an analog-to-digital processing stage.

20. The system of claim 17, wherein said noise suppression circuitry comprises:
a plurality of switches; and
a plurality of storage capacitors, said capacitors being switched into the third stage during an operational phase of the first and second stages.

21. The system of claim 20, wherein said capacitors are switched into the third stage during a reset operational phase of the first and second stages.

22. The system of claim 20, wherein said capacitors are switched into the third stage during a sampling operational phase of the first and second stages.

23. The system of claim 20, wherein said capacitors are also used to supply offsets to an analog-to-digital converter.

24. The system of claim 17, wherein the output of the second stage is cross-coupled with inputs of the third stage.

25. An imaging device comprising:
an array of pixels organized in to even and odd columns; and
a plurality of readout chains connected to the columns, said readout chains being operated such that at least one readout chain substantially suppresses noise associated with said readout chains while at least another readout chain is reading signals from the pixels.

26. An imaging device comprising:
an array of pixels organized in to even and odd columns; and
a plurality of readout chains connected to the columns, said readout chains sharing amplifiers to substantially increase speed and being operated such that at least one readout chain is clamped to a known voltage while at least another readout chain is reading signals from the pixels using the shared amplifiers.

27. A method of fabricating a readout chain for an imaging device, said method comprising the acts of:
forming first and second stages coupled to receive pixel and reset signals from a column of pixels, the first and second stages being cascaded; and
forming a third stage coupled to the output of the second stage, the third stage comprising noise suppression circuitry for substantially suppressing noise associated with the first and second stages.

28. The method of claim 27, wherein said first, second and third stages are cascaded.

29. A method operating an imaging device, said method comprising the acts of:
resetting first and second gain stages of a first readout channel;
inputting pixel and reset signals from a column of pixels into the first gain stage;
storing noise associated with the operation of the first and second stages in a third stage;
amplifying the input signals with a gain of the first gain stage;
amplifying the amplified signals with a gain of the second gain stage; and
processing the amplified signals while subtracting out the stored noise in the third stage.

30. The method of claim 29, wherein noise associated with the operation of the first and second stages is stored after a sampling and hold operation.

31. The method of claim 29, wherein signals from pixels of even columns are processed in a different stage than pixels from an odd columns.

32. The method of claim 29 further comprising the act of converting signals output from the third stage to digital signals.

33. The method of claim 32, wherein said act of processing the amplified signals while subtracting out the stored noise in the third stage further comprises providing offsets for an analog-to-digital conversion process.
